(19) United States
(12) Patent Application Publication
(10) Pub. No.: US 2025/0330577 A1
(43) Pub. Date: Oct. 23, 2025

(54) Template Matching Prediction with Multiple Template Types

(71) Applicant: Ofinno, LLC, Reston, VA (US)

(72) Inventors: Jung Kyung Lee, Reston, VA (US); Damian Ruiz Coll, Reston, VA (US)

(73) Assignee: Ofinno, LLC, Reston, VA (US)

(21) Appl. No.: 19/251,894

(22) Filed: Jun. 27, 2025

Related U.S. Application Data
(63) Continuation of application No. PCT/US2024/010318, filed on Jan. 4, 2024.
(60) Provisional application No. 63/437,118, filed on Jan. 4, 2023.
(60) Provisional application No. 63/438,319, filed on Jan. 11, 2023.

(51) Int. Cl. H04N 19/105; H04N 19/147; H04N 19/176; H04N 19/196

(52) U.S. Cl. CPC H04N 19/105; H04N 19/176; H04N 19/196; H04N 19/147

(57) ABSTRACT

A decoder searches first candidate templates in a first search region and second candidate templates in a second search region to select a reference template based on calculating template matching (TM) costs comprising first TM costs of the first candidate templates and second TM costs of the second candidate templates. The first candidate templates, of first candidate reference blocks (RBs) from the first search region, each corresponds to a current template of a current block. The second candidate templates, of second candidate RBs from the second search region, each corresponds to the current template flipped in a direction. The current block is decoded based on a RB indicated by the reference template.

### CROSS-REFERENCE TO RELATED APPLICATIONS

This application is a continuation of International Application No. PCT/US2024/010318, filed Jan. 4, 2024, which claims the benefits of U.S. Provisional Application No. 63/437,118, filed Jan. 4, 2023, and U.S. Provisional Application No. 63/438,319, filed Jan. 11, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates an exemplary video coding/decoding system in which embodiments of the present disclosure may be implemented.

FIG. 2 illustrates an exemplary encoder in which embodiments of the present disclosure may be implemented.

FIG. 3 illustrates an exemplary decoder in which embodiments of the present disclosure may be implemented.

FIG. 4 illustrates an example quadtree partitioning of a coding tree block (CTB) in accordance with embodiments of the present disclosure.

FIG. 5 illustrates a corresponding quadtree of the example quadtree partitioning of the CTB in FIG. 4 in accordance with embodiments of the present disclosure.

FIG. 6 illustrates example binary and ternary tree partitions in accordance with embodiments of the present disclosure.

FIG. 7 illustrates an example quadtree+multi-type tree partitioning of a CTB in accordance with embodiments of the present disclosure.

FIG. 8 illustrates a corresponding quadtree+multi-type tree of the example quadtree+multi-type tree partitioning of the CTB in FIG. 7 in accordance with embodiments of the present disclosure.

FIG. 9 illustrates an example set of reference samples determined for intra prediction of a current block being encoded or decoded in accordance with embodiments of the present disclosure.

FIG. 10A illustrates the 35 intra prediction modes supported by HEVC in accordance with embodiments of the present disclosure.

FIG. 10B illustrates the 67 intra prediction modes supported by HEVC in accordance with embodiments of the present disclosure.

FIG. 11 illustrates the current block and reference samples from FIG. 9 in a two-dimensional x, y plane in accordance with embodiments of the present disclosure.

FIG. 12 illustrates an example angular mode prediction of the current block from FIG. 9 in accordance with embodiments of the present disclosure.

FIG. 13A illustrates an example of inter prediction performed for a current block in a current picture being encoded in accordance with embodiments of the present disclosure.

FIG. 13B illustrates an example horizontal component and vertical component of a motion vector in accordance with embodiments of the present disclosure.

FIG. 14 illustrates an example of bi-prediction, performed for a current block in accordance with embodiments of the present disclosure.

FIG. 15A illustrates an example location of five spatial candidate neighboring blocks relative to a current block being coded in accordance with embodiments of the present disclosure.

FIG. 15B illustrates an example location of two temporal, co-located blocks relative to a current block being coded in accordance with embodiments of the present disclosure.

FIG. 16 illustrates an example of IBC applied for screen content in accordance with embodiments of the present disclosure.

FIG. 17A illustrates an example of a template matching prediction (TMP) mode for predicting or determining a current block (CB), according to some embodiments.

FIG. 17B illustrates an example of template matching prediction (TMP) mode for predicting or determining a current block (CB), according to some embodiments.

FIG. 18 illustrates an example of RRIBC applied for screen content, according to some embodiments.

FIG. 19 illustrates an example a TMP mode using candidate templates flipped in a horizontal direction, according to some embodiments.

FIG. 20A illustrates an example a TMP mode using candidate templates flipped in a vertical direction, according to some embodiments.

FIG. 20B illustrates an example a TMP mode using candidate templates flipped in a vertical direction, according to some embodiments.

FIG. 21 illustrates an example a TMP mode using a plurality of types of candidate templates, according to some embodiments.

FIG. 22 illustrates an example of template matching for TMP, according to some embodiments.

FIG. 23 illustrates a flowchart of a method using template matching prediction (TMP) with multiple template types to code (e.g., encode or decoded) a current block (CB), according to some embodiments.

FIG. 24 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Representing a video sequence in digital form may require a large number of bits. The data size of a video sequence in digital form may be too large for storage and/or transmission in many applications.

Video encoding may be used to compress the size of a video sequence to provide for more efficient storage and/or transmission. Video decoding may be used to decompress a compressed video sequence for display and/or other forms of consumption.

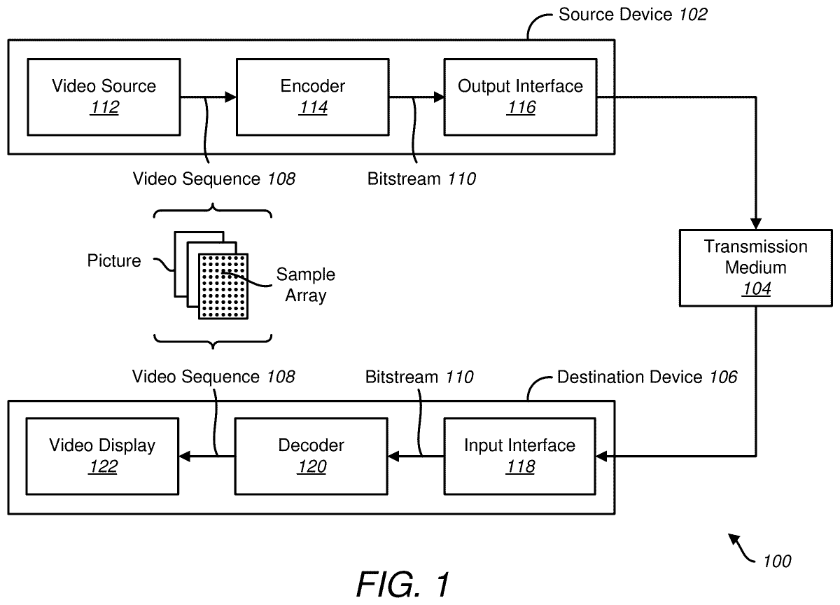

FIG. 1 illustrates an exemplary video coding/decoding system 100 in which embodiments of the present disclosure may be implemented. Video coding/decoding system 100 comprises a source device 102, a transmission medium 104, and a destination device 106. Source device 102 encodes a video sequence 108 into a bitstream 110 for more efficient storage and/or transmission. Source device 102 may store and/or transmit bitstream 110 to destination device 106 via transmission medium 104. Destination device 106 decodes bitstream 110 to display video sequence 108. Destination device 106 may receive bitstream 110 from source device 102 via transmission medium 104. Source device 102 and destination device 106 may be any one of a number of different devices, including a desktop computer, laptop computer, tablet computer, smart phone, wearable device, television, camera, video gaming console, set-top box, or video streaming device.

To encode video sequence 108 into bitstream 110, source device 102 may comprise a video source 112, an encoder 114, and an output interface 116. Video source 112 may provide or generate video sequence 108 from a capture of a natural scene and/or a synthetically generated scene. A synthetically generated scene may be a scene comprising computer generated graphics or screen content. Video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A shown in FIG. 1, a video sequence, such as video sequence 108, may comprise a series of pictures (also referred to as frames). A video sequence may achieve the impression of motion when a constant or variable time is used to successively present pictures of the video sequence. A picture may comprise one or more sample arrays of intensity values. The intensity values may be taken at a series of regularly spaced locations within a picture. A color picture typically comprises a luminance sample array and two chrominance sample arrays. The luminance sample array may comprise intensity values representing the brightness (or luma component, Y) of a picture. The chrominance sample arrays may comprise intensity values that respectively represent the blue and red components of a picture (or chroma components, Cb and Cr) separate from the brightness. Other color picture sample arrays are possible based on different color schemes (e.g., an RGB color scheme). For color pictures, a pixel may refer to all three intensity values for a given location in the three sample arrays used to represent color pictures. A monochrome picture comprises a single, luminance sample array. For monochrome pictures, a pixel may refer to the intensity value at a given location in the single, luminance sample array used to represent monochrome pictures.

Encoder 114 may encode video sequence 108 into bitstream 110. To encode video sequence 108, encoder 114 may apply one or more prediction techniques to reduce redundant information in video sequence 108. Redundant information is information that may be predicted at a decoder and therefore may not be needed to be transmitted to the decoder for accurate decoding of the video sequence. For example, encoder 114 may apply spatial prediction (e.g., intra-frame or intra prediction), temporal prediction (e.g., inter-frame prediction or inter prediction), inter-layer prediction, and/or other prediction techniques to reduce redundant information in video sequence 108. Before applying the one or more prediction techniques, encoder 114 may partition pictures of video sequence 108 into rectangular regions referred to as blocks. Encoder 114 may then encode a block using one or more of the prediction techniques.

For temporal prediction, encoder 114 may search for a block similar to the block being encoded in another picture (also referred to as a reference picture) of video sequence 108. The block determined during the search (also referred to as a prediction block) may then be used to predict the block being encoded. For spatial prediction, encoder 114 may form a prediction block based on data from reconstructed neighboring samples of the block to be encoded within the same picture of video sequence 108. A reconstructed sample refers to a sample that was encoded and then decoded. Encoder 114 may determine a prediction error (also referred to as a residual) based on the difference between a block being encoded and a prediction block. The prediction error may represent non-redundant information that may be transmitted to a decoder for accurate decoding of a video sequence.

Encoder 114 may apply a transform to the prediction error (e.g. a discrete cosine transform (DCT)) to generate transform coefficients. Encoder 114 may form bitstream 110 based on the transform coefficients and other information used to determine prediction blocks (e.g., prediction types, motion vectors, and prediction modes). In some examples, encoder 114 may perform one or more of quantization and entropy coding of the transform coefficients and/or the other information used to determine prediction blocks before forming bitstream 110 to further reduce the number of bits needed to store and/or transmit video sequence 108.

Output interface 116 may be configured to write and/or store bitstream 110 onto transmission medium 104 for transmission to destination device 106. In addition or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one more networks (e.g., the Internet) or file servers configured to store and/or transmit encoded video data.

To decode bitstream 110 into video sequence 108 for display, destination device 106 may comprise an input interface 118, a decoder 120, and a video display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode video sequence 108 from encoded bitstream 110. To decode video sequence 108, decoder 120 may generate prediction blocks for pictures of video sequence 108 in a similar manner as encoder 114 and determine prediction errors for the blocks. Decoder 120 may generate the prediction blocks using prediction types, prediction modes, and/or motion vectors received in bitstream 110 and determine the prediction errors using transform coefficients also received in bitstream 110. Decoder 120 may determine the prediction errors by weighting transform basis functions using the transform coefficients. Decoder 120 may combine the prediction blocks and prediction errors to decode video sequence 108. In some examples, decoder 120 may decode a video sequence that approximates video sequence 108 due to, for example, lossy compression of video sequence 108 by encoder 114 and/or errors introduced into encoded bitstream 110 during transmission to destination device 106.

Video display 122 may display video sequence 108 to a user. Video display 122 may comprise a cathode rate tube (CRT) display, liquid crystal display (LCD), a plasma display, light emitting diode (LED) display, or any other display device suitable for displaying video sequence 108.

It should be noted that video encoding/decoding system 100 is presented byway of example and not limitation. In the example of FIG. 1, video encoding/decoding system 100 may have other components and/or arrangements. For example, video source 112 may be external to source device 102. Similarly, video display 122 may be external to destination device 106 or omitted altogether where video sequence is intended for consumption by a machine and/or storage device. In another example, source device 102 may further comprise a video decoder and destination device 106 may comprise a video encoder. In such an example, source device 102 may be configured to further receive an encoded bit stream from destination device 106 to support two-way video transmission between the devices.

In the example of FIG. 1, encoder 114 and decoder 120 may operate according to any one of a number of proprietary or industry video coding standards. For example, encoder 114 and decoder 120 may operate according to one or more of International Telecommunications Union Telecommunication Standardization Sector (ITU-T) H.263, ITU-T H.264 and Moving Picture Expert Group (MPEG)-4 Visual (also known as Advanced Video Coding (AVC)), ITU-T H.265 and MPEG-H Part 2 (also known as High Efficiency Video Coding (HEVC), ITU-T H.265 and MPEG-I Part 3 (also known as Versatile Video Coding (VV)), the WebM VP8 and VP9 codecs, and AOMedia Video 1 (AV1).

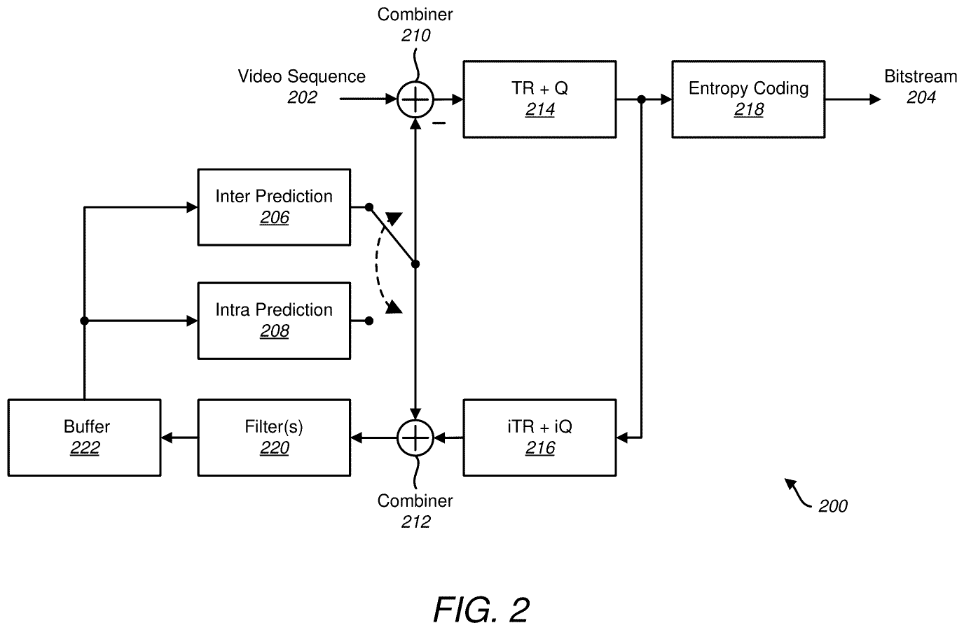

FIG. 2 illustrates an exemplary encoder 200 in which embodiments of the present disclosure may be implemented. Encoder 200 encodes a video sequence 202 into a bitstream 204 for more efficient storage and/or transmission. Encoder 200 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Encoder 200 comprises an inter prediction unit 206, an intra prediction unit 208, combiners 210 and 212, a transform and quantization unit (TR+Q) unit 214, an inverse transform and quantization unit (iTR+iQ) 216, entropy coding unit 218, one or more filters 220, and a buffer 222.

Encoder 200 may partition the pictures of video sequence 202 into blocks and encode video sequence 202 on a block-by-block basis. Encoder 200 may perform a prediction technique on a block being encoded using either inter prediction unit 206 or intra prediction unit 208. Inter prediction unit 206 may perform inter prediction by searching for a block similar to the block being encoded in another, reconstructed picture (also referred to as a reference picture) of video sequence 202. A reconstructed picture refers to a picture that was encoded and then decoded. The block determined during the search (also referred to as a prediction block) may then be used to predict the block being encoded to remove redundant information. Inter prediction unit 206 may exploit temporal redundancy or similarities in scene content from picture to picture in video sequence 202 to determine the prediction block. For example, scene content between pictures of video sequence 202 may be similar except for differences due to motion or affine transformation of the screen content over time.

Intra prediction unit 208 may perform intra prediction by forming a prediction block based on data from reconstructed neighboring samples of the block to be encoded within the same picture of video sequence 202. A reconstructed sample refers to a sample that was encoded and then decoded. Intra prediction unit 208 may exploit spatial redundancy or similarities in scene content within a picture of video sequence 202 to determine the prediction block. For example, the texture of a region of scene content in a picture may be similar to the texture in the immediate surrounding area of the region of the scene content in the same picture.

After prediction, combiner 210 may determine a prediction error (also referred to as a residual) based on the difference between the block being encoded and the prediction block. The prediction error may represent non-redundant information that may be transmitted to a decoder for accurate decoding of a video sequence.

Transform and quantization unit 214 may transform and quantize the prediction error. Transform and quantization unit 214 may transform the prediction error into transform coefficients by applying, for example, a DCT to reduce correlated information in the prediction error. Transform and quantization unit 214 may quantize the coefficients by mapping data of the transform coefficients to a predefined set of representative values. Transform and quantization unit 214 may quantize the coefficients to reduce irrelevant information in bitstream 204. Irrelevant information is information that may be removed from the coefficients without producing visible and/or perceptible distortion in video sequence 202 after decoding.

Entropy coding unit 218 may apply one or more entropy coding methods to the quantized transform coefficients to further reduce the bit rate. For example, entropy coding unit 218 may apply context adaptive variable length coding (CAVLC), context adaptive binary arithmetic coding (CABAC), and syntax-based context-based binary arithmetic coding (SBAC). The entropy coded coefficients are packed to form bitstream 204.

Inverse transform and quantization unit 216 may inverse quantize and inverse transform the quantized transform coefficients to determine a reconstructed prediction error. Combiner 212 may combine the reconstructed prediction error with the prediction block to form a reconstructed block. Filter(s) 220 may filter the reconstructed block using, for example, a deblocking filter and/or a sample-adaptive offset (SAO) filter. Buffer 222 may store the reconstructed block for prediction of one or more other blocks in the same and/or different picture of video sequence 202.

Although not shown in FIG. 2, encoder 200 further comprises an encoder control unit configured to control one or more of the units of encoder 200 shown in FIG. 2. The encoder control unit may control the one or more units of encoder 200 such that bitstream 204 is generated in conformance with the requirements of any one of a number of proprietary or industry video coding standards. For example, The encoder control unit may control the one or more units of encoder 200 such that bitstream 204 is generated in conformance with one or more of ITU-T H.263, AVC, HEVC, VVC, VP8, VP9, and AV1 video coding standards.

Within the constraints of a proprietary or industry video coding standard, the encoder control unit may attempt to minimize or reduce the bitrate of bitstream 204 and maximize or increase the reconstructed video quality. For example, the encoder control unit may attempt to minimize or reduce the bitrate of bitstream 204 given a level that the reconstructed video quality may not fall below, or attempt to maximize or increase the reconstructed video quality given a level that the bit rate of bitstream 204 may not exceed. The encoder control unit may determine/control one or more of: partitioning of the pictures of video sequence 202 into blocks, whether a block is inter predicted by inter prediction unit 206 or intra predicted by intra prediction unit 208, a motion vector for inter prediction of a block, an intra prediction mode among a plurality of intra prediction modes for intra prediction of a block, filtering performed by filter(s) 220, and one or more transform types and/or quantization parameters applied by transform and quantization unit 214. The encoder control unit may determine/control the above based on how the determination/control effects a rate-distortion measure for a block or picture being encoded. The encoder control unit may determine/control the above to reduce the rate-distortion measure for a block or picture being encoded.

After being determined, the prediction type used to encode a block (intra or inter prediction), prediction information of the block (intra prediction mode if intra predicted, motion vector, etc.), and transform and quantization parameters, may be sent to entropy coding unit 218 to be further compressed to reduce the bit rate. For example, entropy coding unit 218 may apply context adaptive variable length coding (CAVLC), context adaptive binary arithmetic coding (CABAC), and syntax-based context-based binary arithmetic coding (SBAC) to compress the prediction type used to encode a block (intra or inter prediction), prediction information of the block (intra prediction mode if intra predicted, motion vector, etc.), and transform and quantization parameters. The prediction type, prediction information, and transform and quantization parameters may be packed with the prediction error to form bitstream 204.

It should be noted that encoder 200 is presented by way of example and not limitation. In other examples, encoder 200 may have other components and/or arrangements. For example, one or more of the components shown in FIG. 2 may be optionally included in encoder 200, such as entropy coding unit 218 and filters(s) 220.

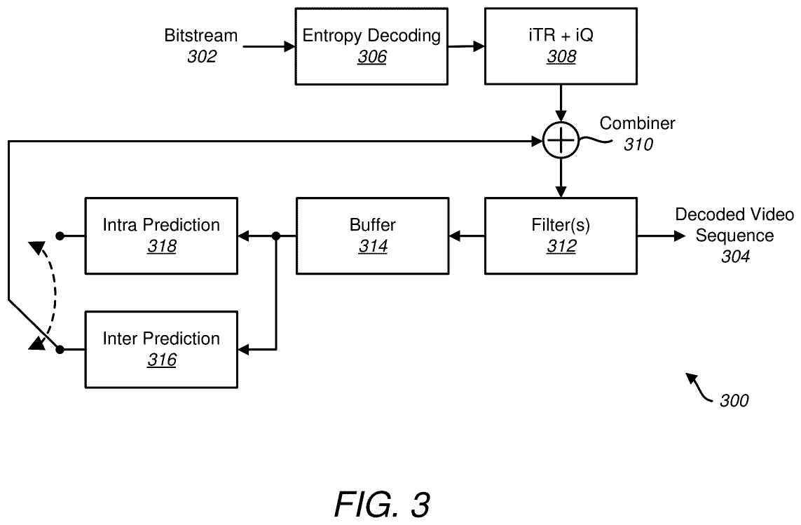

FIG. 3 illustrates an exemplary decoder 300 in which embodiments of the present disclosure may be implemented. Decoder 300 decodes a bitstream 302 into a decoded video sequence 304 for display and/or some other form of consumption. Decoder 300 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Decoder 300 comprises an entropy decoding unit 306, an inverse transform and quantization (iTR+iQ) unit 308, a combiner 310, one or more filters 312, a buffer 314, an inter prediction unit 316, and an intra prediction unit 318.

Although not shown in FIG. 3, decoder 300 further comprises a decoder control unit configured to control one or more of the units of decoder 300 shown in FIG. 3. The decoder control unit may control the one or more units of decoder 300 such that bitstream 302 is decoded in conformance with the requirements of any one of a number of proprietary or industry video coding standards. For example, The decoder control unit may control the one or more units of decoder 300 such that bitstream 302 is decoded in conformance with one or more of ITU-T H.263, AVC, HEVC, VVC, VP8, VP9, and AV1 video coding standards.

The decoder control unit may determine/control one or more of: whether a block is inter predicted by inter prediction unit 316 or intra predicted by intra prediction unit 318, a motion vector for inter prediction of a block, an intra prediction mode among a plurality of intra prediction modes for intra prediction of a block, filtering performed by filter(s) 312, and one or more inverse transform types and/or inverse quantization parameters to be applied by inverse transform and quantization unit 308. One or more of the control parameters used by the decoder control unit may be packed in bitstream 302.

Entropy decoding unit 306 may entropy decode the bitstream 302. For example, entropy decoding unit 306 may apply context adaptive variable length coding (CAVLC), context adaptive binary arithmetic coding (CABAC), and syntax-based context-based binary arithmetic coding (SBAC) to decompress the prediction type used to encode a block (intra or inter prediction), prediction information of the block (intra prediction mode if intra predicted, motion vector, etc.), and transform and quantization parameters. Inverse transform and quantization unit 308 may inverse quantize and inverse transform the quantized transform coefficients to determine a decoded prediction error. Combiner 310 may combine the decoded prediction error with a prediction block to form a decoded block. The prediction block may be generated by intra prediction unit 318 or inter prediction unit 316 as described above with respect to encoder 200 in FIG. 2. Filter(s) 312 may filter the decoded block using, for example, a deblocking filter and/or a sample-adaptive offset (SAO) filter. Buffer 314 may store the decoded block for prediction of one or more other blocks in the same and/or different picture of the video sequence in bitstream 302. Decoded video sequence 304 may be output from filter(s) 312 as shown in FIG. 3.

It should be noted that decoder 300 is presented by way of example and not limitation. In other examples, decoder 300 may have other components and/or arrangements. For example, one or more of the components shown in FIG. 3 may be optionally included in decoder 300, such as entropy decoding unit 306 and filters(s) 312.

It should be further noted that, although not shown in FIGS. 2 and 3, each of encoder 200 and decoder 300 may further comprise an intra block copy unit in addition to inter prediction and intra prediction units. The intra block copy unit may perform similar to an inter prediction unit but predict blocks within the same picture. For example, the intra block copy unit may exploit repeated patterns that appear in screen content. Screen content may include, for example, computer generated text, graphics, and animation.

As mentioned above, video encoding and decoding may be performed on a block-by-block basis. The process of partitioning a picture into blocks may be adaptive based on the content of the picture. For example, larger block partitions may be used in areas of a picture with higher levels of homogeneity to improve coding efficiency.

In HEVC, a picture may be partitioned into non-overlapping square blocks, referred to as coding tree blocks (CTBs), comprising samples of a sample array. A CTB may have a size of 2n×2n samples, where n may be specified by a parameter of the encoding system. For example, n may be 4, 5, or 6. A CTB may be further partitioned by a recursive quadtree partitioning into coding blocks (CBs) of half vertical and half horizontal size. The CTB forms the root of the quadtree. A CB that is not split further as part of the recursive quadtree partitioning may be referred to as a leaf-CB of the quadtree and otherwise as a non-leaf CB of the quadtree. A CB may have a minimum size specified by a parameter of the encoding system. For example, a CB may have a minimum size of 4×4, 8×8, 16×16, 32×32, or 64×64 samples. For inter and intra prediction, a CB may be further partitioned into one or more prediction blocks (PBs) for performing inter and intra prediction. A PB may be a rectangular block of samples on which the same prediction type/mode may be applied. For transformations, a CB may be partitioned into one or more transform blocks (TBs). A TB may be a rectangular block of samples that may determine an applied transform size.

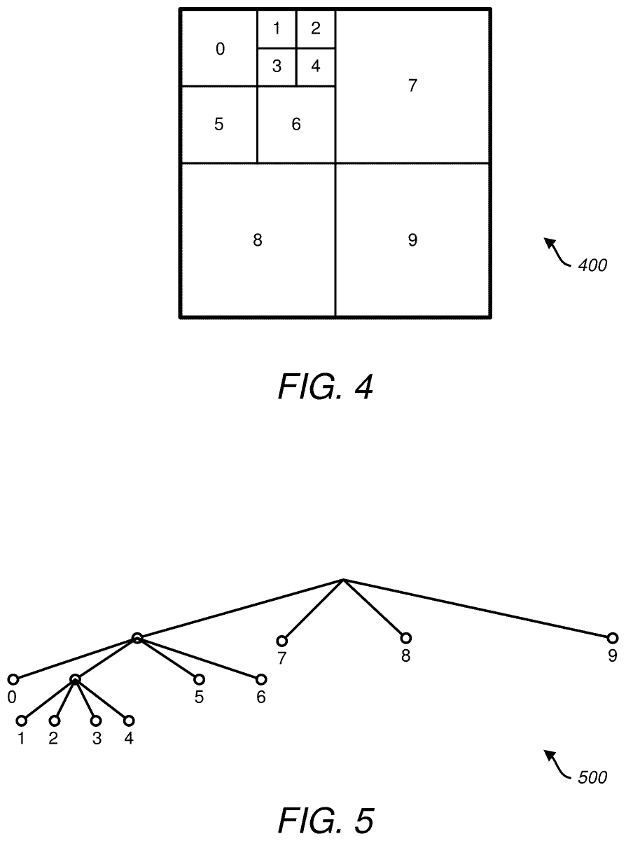

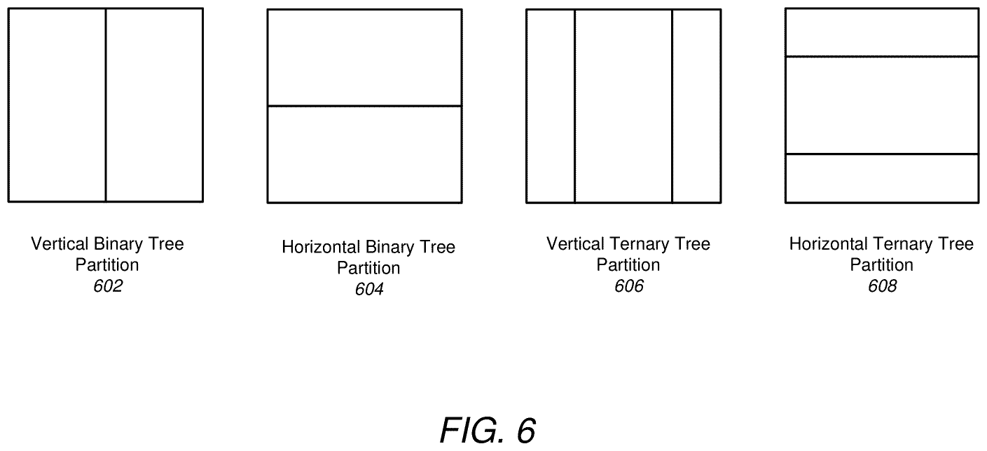

FIG. 4 illustrates an example quadtree partitioning of a CTB 400. FIG. 5 illustrates a corresponding quadtree 500 of the example quadtree partitioning of CTB 400 in FIG. 4. As shown in FIGS. 4 and 5, CTB 400 is first partitioned into four CBs of half vertical and half horizontal size. Three of the resulting CBs of the first level partitioning of CTB 400 are leaf-CBs. The three leaf CBs of the first level partitioning of CTB 400 are respectively labeled 7, 8, and 9 in FIGS. 4 and 5. The non-leaf CB of the first level partitioning of CTB 400 is partitioned into four sub-CBs of half vertical and half horizontal size. Three of the resulting sub-CBs of the second level partitioning of CTB 400 are leaf CBs. The three leaf CBs of the second level partitioning of CTB 400 are respectively labeled 0, 5, and 6 in FIGS. 4 and 5. Finally, the non-leaf CB of the second level partitioning of CTB 400 is partitioned into four leaf CBs of half vertical and half horizontal size. The four leaf CBs are respectively labeled 1, 2, 3, and 4 in FIGS. 4 and 5.

Altogether, CTB 400 is partitioned into 10 leaf CBs respectively labeled 0-9. The resulting quadtree partitioning of CTB 400 may be scanned using a z-scan (left-to-right, top-to-bottom) to form the sequence order for encoding/decoding the CB leaf nodes. The numeric label of each CB leaf node in FIGS. 4 and 5 may correspond to the sequence order for encoding/decoding, with CB leaf node 0 encoded/decoded first and CB leaf node 9 encoded/decoded last. Although not shown in FIGS. 4 and 5, it should be noted that each CB leaf node may comprise one or more PBs and TBs.

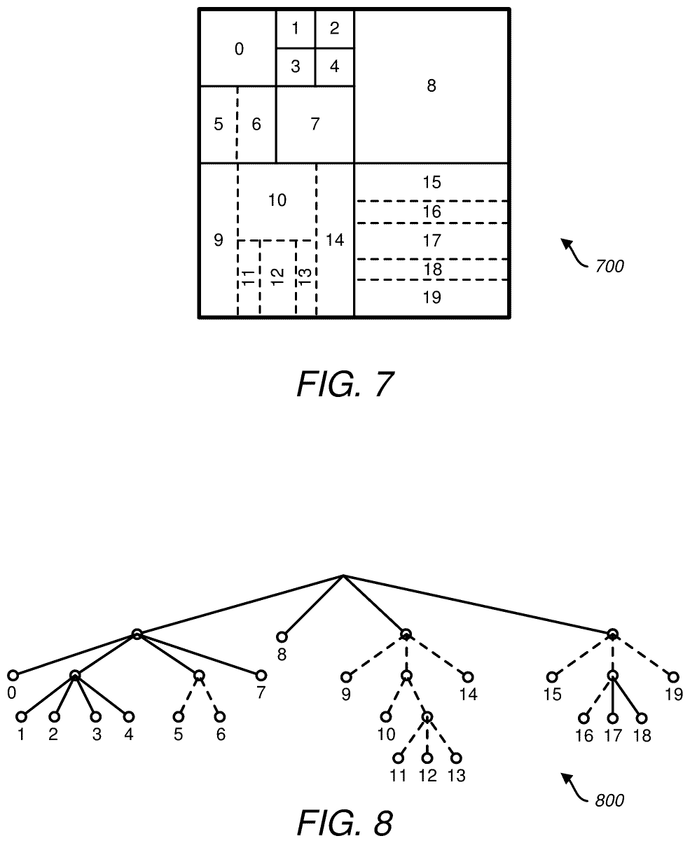

In VVC, a picture may be partitioned in a similar manner as in HEVC. A picture may be first partitioned into non-overlapping square CTBs. The CTBs may then be partitioned by a recursive quadtree partitioning into CBs of half vertical and half horizontal size. In VVC, a quadtree leaf node may be further partitioned by a binary tree or ternary tree partitioning into CBs of unequal sizes. FIG. 6 illustrates example binary and ternary tree partitions. A binary tree partition may divide a parent block in half in either the vertical direction 602 or horizontal direction 604. The resulting partitions may be half in size as compared to the parent block. A ternary tree partition may divide a parent block into three parts in either the vertical direction 606 or horizontal direction 608. The middle partition may be twice as large as the other two end partitions in a ternary tree partition.

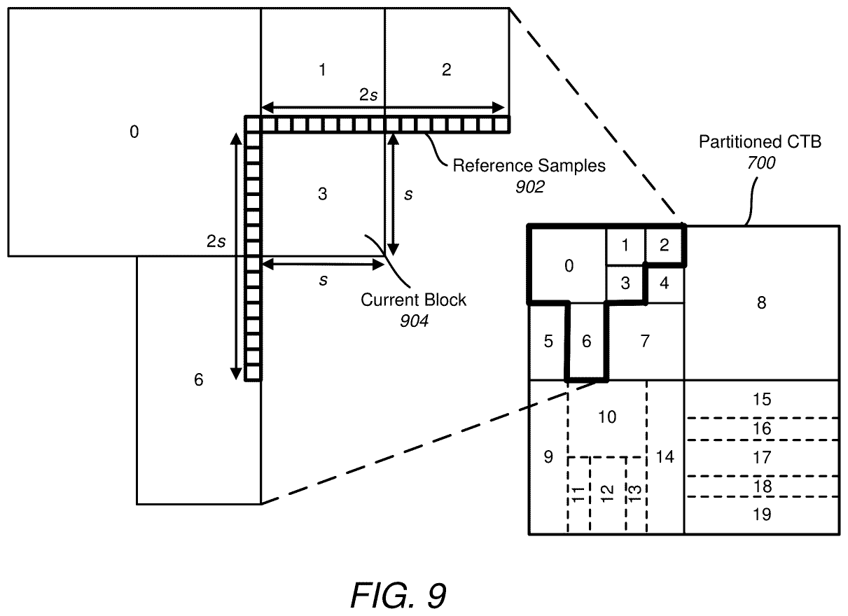

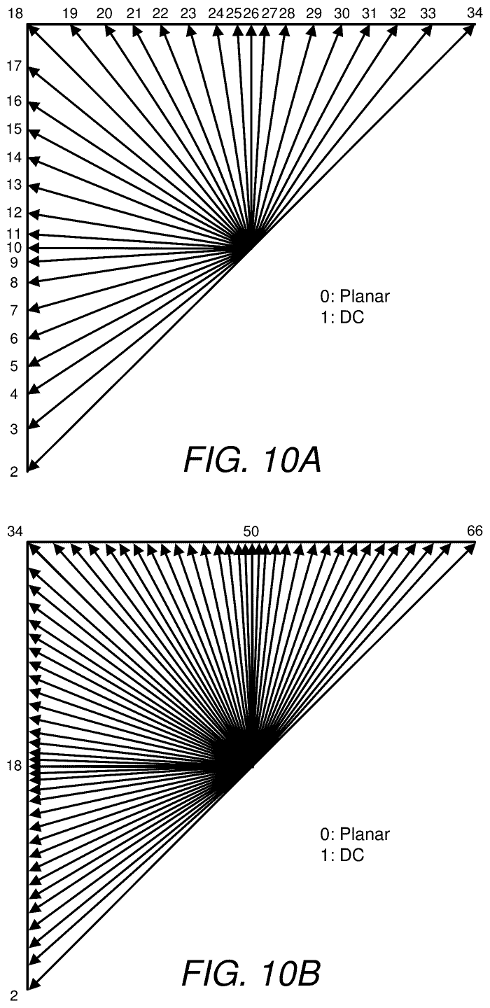

Because of the addition of binary and ternary tree partitioning, in VVC the block partitioning strategy may be referred to as quadtree+multi-type tree partitioning. FIG. 7 illustrates an example quadtree+multi-type tree partitioning of a CTB 700. FIG. 8 illustrates a corresponding quadtree+multi-type tree 800 of the example quadtree+multi-type tree partitioning of CTB 700 in FIG. 7. In both FIGS. 7 and 8, quadtree splits are shown in solid lines and multi-type tree splits are shown in dashed lines. For ease of explanation, CTB 700 is shown with the same quadtree partitioning as CTB 400 described in FIG. 4. Therefore, description of the quadtree partitioning of CTB 700 is omitted. The description of the additional multi-type tree partitions of CTB 700 is made relative to three leaf-CBs shown in FIG. 4 that have been further partitioned using one or more binary and ternary tree partitions. The three leaf-CBs in FIG. 4 that are shown in FIG. 7 as being further partitioned are leaf-CBs 5, 8, and 9.

Starting with leaf-CB 5 in FIG. 4, FIG. 7 shows this leaf-CB partitioned into two CBs based on a vertical binary tree partitioning. The two resulting CBs are leaf-CBs respectively labeled 5 and 6 in FIGS. 7 and 8. With respect to leaf-CB 8 in FIG. 4, FIG. 7 shows this leaf-CB partitioned into three CBs based on a vertical ternary tree partition. Two of the three resulting CBs are leaf-CBs respectively labeled 9 and 14 in FIGS. 7 and 8. The remaining, non-leaf CB is partitioned first into two CBs based on a horizontal binary tree partition, one of which is a leaf-CB labeled 10 and the other of which is further partitioned into three CBs based on a vertical ternary tree partition. The resulting three CBs are leaf-CBs respectively labeled 11, 12, and 13 in FIGS. 7 and 8. Finally, with respect to leaf-CB 9 in FIG. 4, FIG. 7 shows this leaf-CB partitioned into three CBs based on a horizontal ternary tree partition. Two of the three CBs are leaf-CBs respectively labeled 15 and 19 in FIGS. 7 and 8. The remaining, non-leaf CB is partitioned into three CBs based on another horizontal ternary tree partition. The resulting three CBs are all leaf-CBs respectively labeled 16, 17, and 18 in FIGS. 7 and 8.

Altogether, CTB 700 is partitioned into 20 leaf CBs respectively labeled 0-19. The resulting quadtree+multi-type tree partitioning of CTB 700 may be scanned using a z-scan (left-to-right, top-to-bottom) to form the sequence order for encoding/decoding the CB leaf nodes. The numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and TBs.

In addition to specifying various blocks (e.g., CTB, CB, PB, TB), HEVC and VVC further define various units. While blocks may comprise a rectangular area of samples in a sample array, units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bit stream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

It should be noted that the term block may be used to refer to any of a CTB, CB, PB, TB, CTU, CU, PU, or TU in the context of HEVC and VVC. It should be further noted that the term block may be used to refer to similar data structures in the context of other video coding standards. For example, the term block may refer to a macroblock in AVC, a macroblock or sub-block in VP8, a superblock or sub-block in VP9, or a superblock or sub-block in AV1.

In intra prediction, samples of a block to be encoded (also referred to as the current block) may be predicted from samples of the column immediately adjacent to the left-most column of the current block and samples of the row immediately adjacent to the top-most row of the current block. The samples from the immediately adjacent column and row may be jointly referred to as reference samples. Each sample of the current block may be predicted by projecting the position of the sample in the current block in a given direction (also referred to as an intra prediction mode) to a point along the reference samples. The sample may be predicted by interpolating between the two closest reference samples of the projection point if the projection does not fall directly on a reference sample. A prediction error (also referred to as a residual) may be determined for the current block based on differences between the predicted sample values and the original sample values of the current block.

At an encoder, this process of predicting samples and determining a prediction error based on a difference between the predicted samples and original samples may be performed for a plurality of different intra prediction modes, including non-directional intra prediction modes. The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block using the intra prediction mode indicated by the encoder and combining the predicted samples with the prediction error.

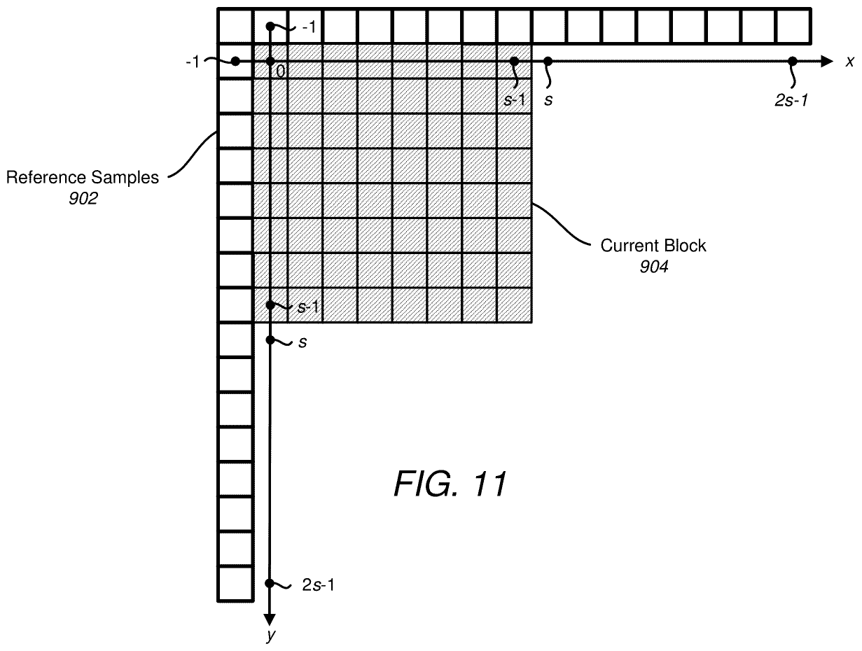

FIG. 9 illustrates an example set of reference samples 902 determined for intra prediction of a current block 904 being encoded or decoded. In FIG. 9, current block 904 corresponds to block 3 of partitioned CTB 700 in FIG. 7. As explained above, the numeric labels 0-19 of the blocks of partitioned CTB 700 may correspond to the sequence order for encoding/decoding the blocks and are used as such in the example of FIG. 9.

Given current block 904 is of w×h samples in size, reference samples 902 may extend over 2w samples of the row immediately adjacent to the top-most row of current block 904, 2h samples of the column immediately adjacent to the left-most column of current block 904, and the top left neighboring corner sample to current block 904. In the example of FIG. 9, current block 904 is square, so w=h=s. For constructing the set of reference samples 902, available samples from neighboring blocks of current block 904 may be used. Samples may not be available for constructing the set of reference samples 902 if, for example, the samples would lie outside the picture of the current block, the samples are part of a different slice of the current block (where the concept of slices are used), and/or the samples belong to blocks that have been inter coded and constrained intra prediction is indicated. When constrained intra prediction is indicated, intra prediction may not be dependent on inter predicted blocks.

In addition to the above, samples that may not be available for constructing the set of reference samples 902 include samples in blocks that have not already been encoded and reconstructed at an encoder or decoded at a decoder based on the sequence order for encoding/decoding. This restriction may allow identical prediction results to be determined at both the encoder and decoder. In FIG. 9, samples from neighboring blocks 0, 1, and 2 may be available to construct reference samples 902 given that these blocks are encoded and reconstructed at an encoder and decoded at a decoder prior to coding of current block 904. This assumes there are no other issues, such as those mentioned above, preventing the availability of samples from neighboring blocks 0, 1, and 2. However, the portion of reference samples 902 from neighboring block 6 may not be available due to the sequence order for encoding/decoding.

Unavailable ones of reference samples 902 may be filled with available ones of reference samples 902. For example, an unavailable reference sample may be filled with a nearest available reference sample determined by moving in a clock-wise direction through reference samples 902 from the position of the unavailable reference. If no reference samples are available, reference samples 902 may be filled with the mid-value of the dynamic range of the picture being coded.

It should be noted that reference samples 902 may be filtered based on the size of current block 904 being coded and an applied intra prediction mode. It should be further noted that FIG. 9 illustrates only one exemplary determination of reference samples for intra prediction of a block. In some proprietary and industry video coding standards, reference samples may be determined in a different manner than discussed above. For example, multiple reference lines may be used in other instances, such as used in WC.

After reference samples 902 are determined and optionally filtered, samples of current block 904 may be intra predicted based on reference samples 902. Most encoders/decoders support a plurality of intra prediction modes in accordance with one or more video coding standards. For example, HEVC supports 35 intra prediction modes, including a planar mode, a DC mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture.

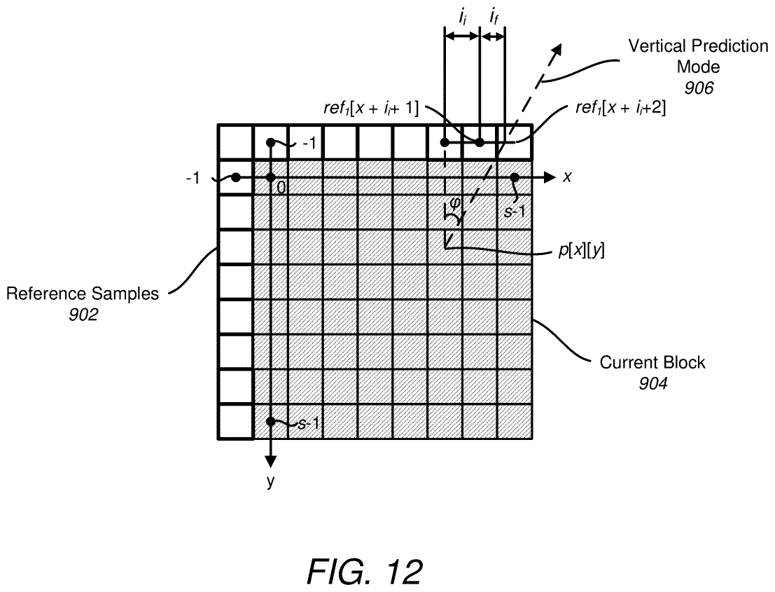

FIG. 10A illustrates the 35 intra prediction modes supported by HEVC. The 35 intra prediction modes are identified by indices 0 to 34. Prediction mode 0 corresponds to planar mode. Prediction mode 1 corresponds to DC mode. Prediction modes 2-34 correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B illustrates the 67 intra prediction modes supported by VVC. The 67 intra prediction modes are identified by indices 0 to 66. Prediction mode 0 corresponds to planar mode. Prediction mode 1 corresponds to DC mode. Prediction modes 2-66 correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Because blocks in VVC may be non-square, some of the intra prediction modes illustrated in FIG. 10B may be adaptively replaced by wide-angle directions.

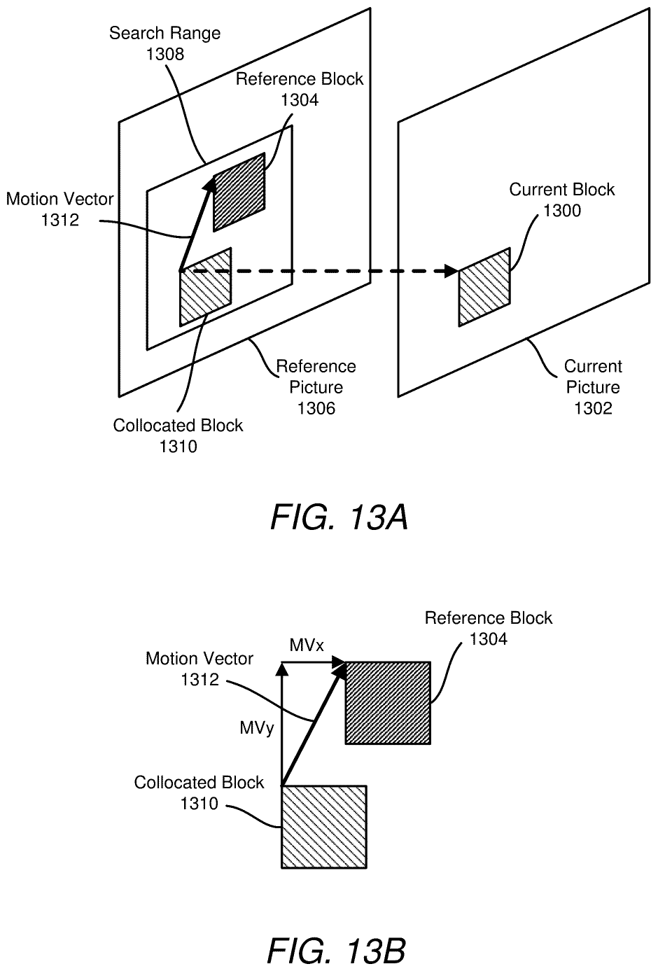

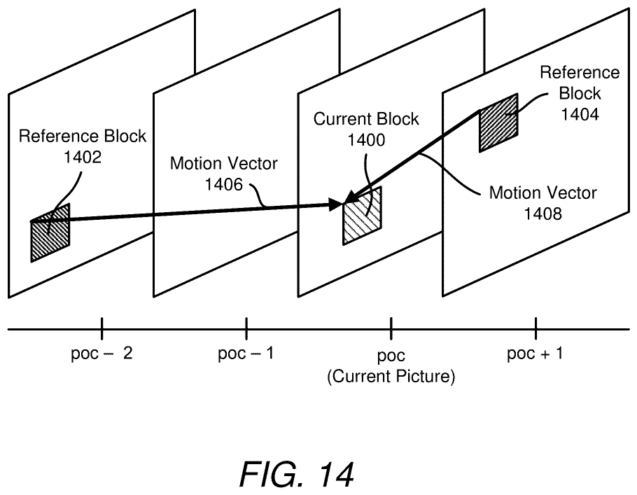

To further describe the application of intra prediction modes to determine a prediction of a current block, reference is made to FIGS. 11 and 12. In FIG. 11, current block 904 and reference samples 902 from FIG. 9 are shown in a two-dimensional x, y plane, where a sample may be referenced as p[x][y]. In order to simplify the prediction process, reference samples 902 may be placed in two, one-dimensional arrays. Reference samples 902 above current block 904 may be placed in the one-dimensional array ref₁[x]:

$${ref}_{1} [ x ] = p [ - 1 + x ] [ - 1 ] , ( x \geq 0 ) \qquad ( 1 )$$

Reference samples 902 to the left of current block 904 may be placed in the one-dimensional array ref₂[x]:

$${ref}_{2} [ y ] = p [ - 1 ] [ - 1 + y ] , ( y \geq 0 ) \qquad ( 2 )$$

For planar mode, a sample at location [x][y] in current block 904 may be predicted by calculating the mean of two interpolated values. The first of the two interpolated values may be based on a horizontal linear interpolation at location [x][y] in current block 904. The second of the two interpolated values may be based on a vertical linear interpolation at location [x][y] in current block 904. The predicted sample p[x][y] in current block 904 may be calculated as

$$p [ x ] [ y ] = \frac{1}{2 \cdot s} ( h [ x ] [ y ] + v [ x ] [ y ] + s ) \qquad ( 3 )$$

$$where$$

$$h [ x ] [ y ] = ( s - x - 1 ) \cdot {ref}_{2} [ y ] + ( x + 1 ) \cdot {ref}_{1} [ s ] \qquad ( 4 )$$

may be the horizontal linear interpolation at location [x][y] in current block 904 and

$$v [ x ] [ y ] = ( s - y - 1 ) \cdot {ref}_{1} [ x ] + ( y + 1 ) \cdot {ref}_{2} [ s ] \qquad ( 5 )$$

may be the vertical linear interpolation at location [x][y] in current block 904.

For DC mode, a sample at location [x][y] in current block 904 may be predicted by the mean of the reference samples 902. The predicted value sample p[x][y] in current block 904 may be calculated as

$$p [ x ] [ y ] = \frac{1}{2 \cdot s} ( {\sum }_{x = 0}^{s - 1} {ref}_{1} [ x ] + {\sum }_{y = 0}^{s - 1} {ref}_{2} [ y ] ) \qquad ( 6 )$$

For angular modes, a sample at location [x][y] in current block 904 may be predicted by projecting the location [x][y] in a direction specified by a given angular mode to a point on the horizontal or vertical line of samples comprising reference samples 902. The sample at location [x][y] may be predicted by interpolating between the two closest reference samples of the projection point if the projection does not fall directly on a reference sample. The direction specified by the angular mode may be given by an angle φ defined relative to the y-axis for vertical prediction modes (e.g., modes 19-34 in HEVC and modes 35-66 in VVC) and relative to the x-axis for horizontal prediction modes (e.g., modes 2-18 in HEVC and modes 2-34 in VVC).

FIG. 12 illustrates a prediction of a sample at location [x][y] in current block 904 for a vertical prediction mode 906 given by an angle φ. For vertical prediction modes, the location [x][y] in current block 904 is projected to a point (referred to herein as the “projection point”) on the horizontal line of reference samples ref₁[x]. Reference samples 902 are only partially shown in FIG. 12 for ease of illustration. Because the projection point falls at a fractional sample position between two reference samples in the example of FIG. 12, the predicted sample p[x][y] in current block 904 may be calculated by linearly interpolating between the two reference samples as follows PUP-E

$$p [ x ] [ y ] = ( 1 - {i}_{f} ) \cdot {ref}_{1} [ x + {i}_{i} + 1 ] + {i}_{f} \cdot {ref}_{1} [ x + {i}_{i} + 2 ] \qquad ( 7 )$$

where iᵢ is the integer part of the horizontal displacement of the projection point relative to the location [x][y] and may calculated as a function of the tangent of the angle φ of the vertical prediction mode 906 as follows

$${i}_{i} = ⌊ ( y + 1 ) \cdot tan φ ⌋ , \qquad ( 8 )$$

and i_{f} is the fractional part of the horizontal displacement of the projection point relative to the location [x][y] and may be calculated as

$${i}_{f} = ( ( y + 1 ) \cdot tan φ ) - ⌊ ( y + 1 ) \cdot tan φ ⌋ . \qquad ( 9 )$$

where └⋅┘ is the integer floor.

For horizontal prediction modes, the position [x][y] of a sample in current block 904 may be projected onto the vertical line of reference samples ref₂[y]. Sample prediction for horizontal prediction

$$p [ x ] [ y ] = ( 1 - {i}_{f} ) \cdot {ref}_{2} [ y + {i}_{i} + 1 ] + {i}_{f} \cdot {ref}_{2} [ y + {i}_{i} + 2 ] \qquad ( 10 )$$

where iᵢ is the integer part of the vertical displacement of the projection point relative to the location [x][y] and may be calculated as a function of the tangent of the angle cp of the horizontal prediction mode as follows

$${i}_{i} = ⌊ ( x + 1 ) \cdot tan φ ⌋ , \qquad ( 11 )$$

and i_{f} is the fractional part of the vertical displacement of the projection point relative to the location [x][y] and may be calculated as

$${i}_{f} = ( ( x + 1 ) \cdot tan φ ) - ⌊ ( x + 1 ) \cdot tan φ ⌋ . \qquad ( 12 )$$

where └⋅┘ is the integer floor.

The interpolation functions of (7) and (10) may be implemented by an encoder or decoder, such as encoder 200 in FIG. 2 or decoder 300 in FIG. 3, as a set of two-tap finite impulse response (FIR) filters. The coefficients of the two-tap FIR filters may be respectively given by (1−1_{f}) and i_{f}. In the above angular intra prediction examples, the predicted sample p[x][y] may be calculated with some predefined level of sample accuracy, such as 1/32 sample accuracy. For 1/32 sample accuracy, the set of two-tap FIR interpolation filters may comprise up to 32 different two-tap FIR interpolation filters—one for each of the 32 possible values of the fractional part of the projected displacement i_{f}. In other examples, different levels of sample accuracy may be used.

In an embodiment, the two-tap interpolation FIR filter may be used for predicting chroma samples. For luma samples, a different interpolation technique may be used. For example, for luma samples a four-tap FIR filter may be used to determine a predicted value of a luma sample. For example, the four tap FIR filter may have coefficients determined based on i_{f}, similar to the two-tap FIR filter. For 1/32 sample accuracy, a set of 32 different four-tap FIR filters may comprise up to 32 different four-tap FIR filters—one for each of the 32 possible values of the fractional part of the projected displacement i_{f}. In other examples, different levels of sample accuracy may be used. The set of four-tap FIR filters may be stored in a look-up table (LUT) and referenced based on i_{f}. The value of the predicted sample p[x][y], for vertical prediction modes, may be determined based on the four-tap FIR filter as follows:

$$p [ x ] [ y ] = {\sum }_{i = 0}^{3} fT [ i ] * ref [ x + iIdx + i ] \qquad ( 13 )$$

where ft[i], i=0 . . . 3, are the filter coefficients. The value of the predicted sample p[x][y], for horizontal prediction modes, may be determined based on the four-tap FIR filter as follows:

$$p [ x ] [ y ] = {\sum }_{i = 0}^{3} fT [ i ] * ref [ y + iIdx + i ] . \qquad ( 14 )$$

It should be noted that supplementary reference samples may be constructed for the case where the position [x][y] of a sample in current block 904 to be predicted is projected to a negative x coordinate, which happens with negative vertical prediction angles φ. The supplementary reference samples may be constructed by projecting the reference samples in ref₂[y] in the vertical line of reference samples 902 to the horizontal line of reference samples 902 using the negative vertical prediction angle φ. Supplemental reference samples may be similarly for the case where the position [x][y] of a sample in current block 904 to be predicted is projected to a negative y coordinate, which happens with negative horizontal prediction angles φ. The supplementary reference samples may be constructed by projecting the reference samples in ref₁[x] on the horizontal line of reference samples 902 to the vertical line of reference samples 902 using the negative horizontal prediction angle φ.

An encoder may predict the samples of a current block being encoded, such as current block 904, for a plurality of intra prediction modes as explained above. For example, the encoder may predict the samples of the current block for each of the 35 intra prediction modes in HEVC or 67 intra prediction modes in VVC. For each intra prediction mode applied, the encoder may determine a prediction error for the current block based on a difference (e.g., sum of squared differences (SSD), sum of absolute differences (SAD), or sum of absolute transformed differences (SATD)) between the prediction samples determined for the intra prediction mode and the original samples of the current block. The encoder may select one of the intra prediction modes to encode the current block based on the determined prediction errors. For example, the encoder may select an intra prediction mode that results in the smallest prediction error for the current block. In another example, the encoder may select the intra prediction mode to encode the current block based on a rate-distortion measure (e.g., Lagrangian rate-distortion cost) determined using the prediction errors. The encoder may send an indication of the selected intra prediction mode and its corresponding prediction error to a decoder for decoding of the current block.

Similar to an encoder, a decoder may predict the samples of a current block being decoded, such as current block 904, for an intra prediction mode as explained above. For example, the decoder may receive an indication of an angular intra prediction mode from an encoder for a block. The decoder may construct a set of reference samples and perform intra prediction based on the angular intra prediction mode indicated by the encoder for the block in a similar manner as discussed above for the encoder. The decoder would add the predicted values of the samples of the block to a residual of the block to reconstruct the block. In another embodiment, the decoder may not receive an indication of an angular intra prediction mode from an encoder for a block. Instead, the decoder may determine an intra prediction mode through other, decoder-side means.

Although the description above was primarily made with respect to intra prediction modes in HEVC and VVC, it will be understood that the techniques of the present disclosure described above and further below may be applied to other intra prediction modes, including those of other video coding standards like VP8, VP9, AV1, and the like.

As explained above, intra prediction may exploit correlations between spatially neighboring samples in the same picture of a video sequence to perform video compression. Inter prediction is another coding tool that may be used to exploit correlations in the time domain between blocks of samples in different pictures of the video sequence to perform video compression. In general, an object may be seen across multiple pictures of a video sequence. The object may move (e.g., by some translation and/or affine motion) or remain stationary across the multiple pictures. A current block of samples in a current picture being encoded may therefore have a corresponding block of samples in a previously decoded picture that accurately predicts the current block of samples. The corresponding block of samples may be displaced from the current block of samples due to movement of an object, represented in both blocks, across the respective pictures of the blocks. The previously decoded picture may be referred to as a reference picture and the corresponding block of samples in the reference picture may be referred to as a reference block or motion compensated prediction. An encoder may use a block matching technique to estimate the displacement (or motion) and determine the reference block in the reference picture.

Similar to intra prediction, once a prediction for a current block is determined and/or generated using inter prediction, an encoder may determine a difference between the current block and the prediction. The difference may be referred to as a prediction error or residual. The encoder may then store and/or signal in a bitstream the prediction error and other related prediction information for decoding or other forms of consumption. A decoder may decode the current block by predicting the samples of the current block using the prediction information and combining the predicted samples with the prediction error.

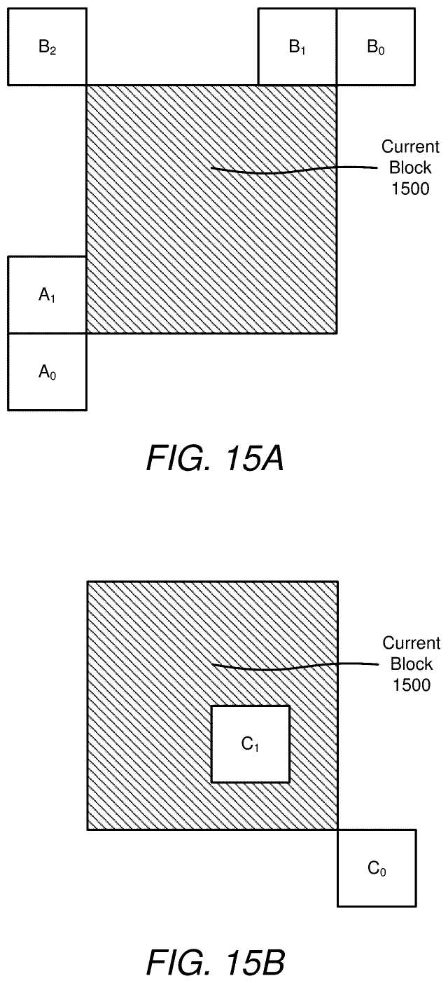

FIG. 13A illustrates an example of inter prediction performed for a current block 1300 in a current picture 1302 being encoded. An encoder, such as encoder 200 in FIG. 2, may perform inter prediction to determine and/or generate a reference block 1304 in a reference picture 1306 to predict current block 1300. Reference pictures, like reference picture 1306, are prior decoded pictures available at the encoder and decoder. Availability of a prior decoded picture may depend on whether the prior decoded picture is available in a decoded picture buffer at the time current block 1300 is being encoded or decoded. The encoder may, for example, search one or more reference pictures for a reference block that is similar to current block 1300. The encoder may determine a “best matching” reference block from the blocks tested during the searching process as reference block 1304. The encoder may determine that reference block 1304 is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), or sum of absolute transformed differences (SATD)) between the prediction samples of reference block 1304 and the original samples of current block 1300.

The encoder may search for reference block 1304 within a search range 1308. Search range 1308 may be positioned around the collocated position (or block) 1310 of current block 1300 in reference picture 1306. In some instances, search range 1308 may at least partially extend outside of reference picture 1306. When extending outside of reference picture 1306, constant boundary extension may be used such that the values of the samples in the row or column of reference picture 1306, immediately adjacent to the portion of search range 1308 extending outside of reference picture 1306, are used for the “sample” locations outside of reference picture 1306. All or a subset of potential positions within search range 1308 may be searched for reference block 1304. The encoder may utilize any one of a number of different search implementations to determine and/or generate reference block 1304. For example, the encoder may determine a set of a candidate search positions based on motion information of neighboring blocks to current block 1300.

One or more reference pictures may be searched by the encoder during inter prediction to determine and/or generate the best matching reference block. The reference pictures searched by the encoder may be included in one or more reference picture lists. For example, in HEVC and VVC, two reference picture lists may be used, a reference picture list 0 and a reference picture list 1. A reference picture list may include one or more pictures. Reference picture 1306 of reference block 1304 may be indicated by a reference index pointing into a reference picture list comprising reference picture 1306.

The displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVx) and a vertical component (MVy) relative to the position of current block 1300. FIG. 13B illustrates the horizontal component and vertical component of motion vector 1312. A motion vector, such as motion vector 1312, may have fractional or integer resolution. A motion vector with fractional resolution may point between two samples in a reference picture to provide a better estimation of the motion of current block 1300. For example, a motion vector may have ½, ¼, ⅛, 1/16, or 1/32 fractional sample resolution. When a motion vector points to a non-integer sample value in the reference picture, interpolation between samples at integer positions may be used to generate the reference block and its corresponding samples at fractional positions. The interpolation may be performed by a filter with two or more taps.

Once reference block 1304 is determined and/or generated for current block 1300 using inter prediction, the encoder may determine a difference (e.g., a corresponding sample-by-sample difference) between reference block 1304 and current block 1300. The difference may be referred to as a prediction error or residual. The encoder may then store and/or signal in a bitstream the prediction error and the related motion information for decoding or other forms of consumption. The motion information may include motion vector 1312 and a reference index pointing into a reference picture list comprising reference picture 1306. In other instances, the motion information may include an indication of motion vector 1312 and an indication of the reference index pointing into the reference picture list comprising reference picture 1306. A decoder may decode current block 1300 by determining and/or generating reference block 1304, which forms the prediction of current block 1300, using the motion information and combining the prediction with the prediction error.

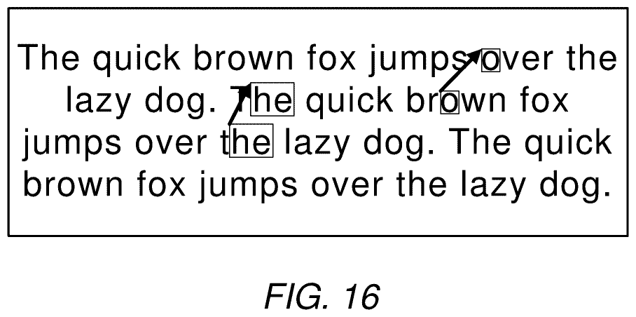

In FIG. 13A, inter prediction is performed using one reference picture 1306 as the source of the prediction for current block 1300. Because the prediction for current block 1300 comes from a single picture, this type of inter prediction is referred to as uni-prediction. FIG. 14 illustrates another type of inter prediction, referred to as bi-prediction, performed for a current block 1400. In bi-prediction, the source of the prediction for a current block 1400 comes from two pictures. Bi-prediction may be useful, for example, where the video sequence comprises fast motion, camera panning or zooming, or scene changes. Bi-prediction may also be useful to capture fade outs of one scene or fade outs from one scene to another, where two pictures are effectively displayed simultaneously with different levels of intensity.

Whether uni-prediction or both uni-prediction and bi-prediction are available for performing inter prediction may depend on a slice type of current block 1400. For P slices, only uni-prediction may be available for performing inter prediction. For B slices, either uni-prediction or bi-prediction may be used. When uni-prediction is performed, an encoder may determine and/or generate a reference block for predicting current block 1400 from reference picture list 0. When bi-prediction is performed, an encoder may determine and/or generate a first reference block for predicting current block 1400 from reference picture list 0 and determine and/or generate a second reference block for predicting current block 1400 from reference picture list 1.

In FIG. 14, inter-prediction is performed using bi-prediction, where two reference blocks 1402 and 1404 are used to predict current block 1400. Reference block 1402 may be in a reference picture of one of reference picture list 0 or 1, and reference block 1404 may be in a reference picture of the other one of reference picture list 0 or 1. As shown in FIG. 14, reference block 1402 is in a picture that precedes the current picture of current block 1400 in terms of picture order count (POC), and reference block 1402 is in a picture that proceeds the current picture of current block 1400 in terms of POC. In other examples, the reference pictures may both precede or proceed the current picture in terms of POC. POC is the order in which pictures are output from, for example, a decoded picture buffer and is the order in which pictures are generally intended to be displayed. However, it should be noted that pictures that are output are not necessarily displayed but may undergo different processing or consumption, such as transcoding. In other examples, the two reference blocks determined and/or generated using bi-prediction may come from the same reference picture. In such an instance, the reference picture may be included in both reference picture list 0 and reference picture list 1.

A configurable weight and offset value may be applied to the one or more inter prediction reference blocks. An encoder may enable the use of weighted prediction using a flag in a picture parameter set (PPS) and signal the weighting and offset parameters in the slice segment header for the current block. Different weight and offset parameters may be signaled for luma and chroma components.

Once reference blocks 1402 and 1404 are determined and/or generated for current block 1400 using inter prediction, the encoder may determine a difference between current block 1400 and each of reference blocks 1402 and 1404. The differences may be referred to as prediction errors or residuals. The encoder may then store and/or signal in a bitstream the prediction errors and their respective related motion information for decoding or other forms of consumption. The motion information for reference block 1402 may include motion vector 1406 and the reference index pointing into the reference picture list comprising the reference picture of reference block 1402. In other instances, the motion information for reference block 1402 may include an indication of motion vector 1406 and an indication of the reference index pointing into the reference picture list comprising the reference picture of reference block 1402. The motion information for reference block 1404 may include motion vector 1408 and the reference index pointing into the reference picture list comprising the reference picture of reference block 1404. In other instances, the motion information for reference block 1404 may include an indication of motion vector 1408 and an indication of the reference index pointing into the reference picture list comprising the reference picture of reference block 1404. A decoder may decode current block 1400 by determining and/or generating reference blocks 1402 and 1404, which together form the prediction of current block 1400, using their respective motion information and combining the predictions with the prediction errors.

In HEVC, VVC, and other video compression schemes, motion information may be predictively coded before being stored or signaled in a bit stream. The motion information for a current block may be predictively coded based on the motion information of neighboring blocks of the current block. In general, the motion information of the neighboring blocks is often correlated with the motion information of the current block because the motion of an object represented in the current block is often the same or similar to the motion of objects in the neighboring blocks. Two of the motion information prediction techniques in HEVC and VVC include advanced motion vector prediction (AMVP) and inter prediction block merging.

An encoder, such as encoder 200 in FIG. 2, may code a motion vector using the AMVP tool as a difference between the motion vector of a current block being coded and a motion vector predictor (MVP). An encoder may select the MVP from a list of candidate MVPs. The candidate MVPs may come from previously decoded motion vectors of neighboring blocks in the current picture of the current block or blocks at or near the collocated position of the current block in other reference pictures. Both the encoder and decoder may generate or determine the list of candidate MVPs.

After the encoder selects an MVP from the list of candidate MVPs, the encoder may signal, in a bitstream, an indication of the selected MVP and a motion vector difference (MVD). The encoder may indicate the selected MVP in the bitstream by an index pointing into the list of candidate MVPs. The MVD may be calculated based on the difference between the motion vector of the current block and the selected MVP. For example, for a motion vector represented by a horizontal component (MVx) and a vertical displacement (MVy) relative to the position of the current block being coded, the MVD may be represented by two components calculated as follows:

$${MVD}_{x} = {MV}_{x} - {MVP}_{x} \qquad ( 15 )$$

$${MVD}_{y} = {MV}_{y} - {MVP}_{y} \qquad ( 16 )$$

where MVDₓ and MVD_{y} respectively represent the horizontal and vertical components of the MVD, and MVPₓ and MVP_{y} respectively represent the horizontal and vertical components of the MVP. A decoder, such as decoder 300 in FIG. 3, may decode the motion vector by adding the MVD to the MVP indicated in the bitstream. The decoder may then decode the current block by determining and/or generating the reference block, which forms the prediction of the current block, using the decoded motion vector and combining the prediction with the prediction error.

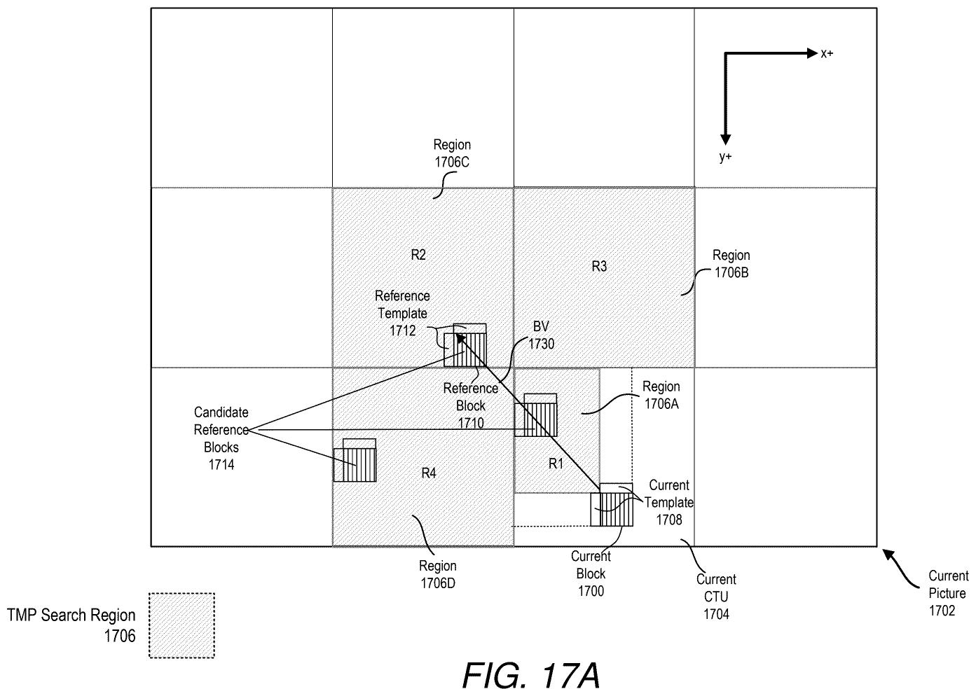

In HEVC and VVC, the list of candidate MVPs for AMVP may comprise two candidates referred to as candidates A and B. Candidates A and B may include up to two spatial candidate MVPs derived from five spatial neighboring blocks of the current block being coded, one temporal candidate MVP derived from two temporal, co-located blocks when both spatial candidate MVPs are not available or are identical, or zero motion vectors when the spatial, temporal, or both candidates are not available. FIG. 15A illustrates the location of the five spatial candidate neighboring blocks relative to a current block 1500 being encoded. The five spatial candidate neighboring blocks are respectively denoted A₀, A₁, B₀, B₁, and B₂. FIG. 15B illustrates the location of the two temporal, co-located blocks relative to current block 1500 being coded. The two temporal, co-located blocks are denoted C₀ and C₁ and are included in a reference picture that is different from the current picture of current block 1500.

An encoder, such as encoder 200 in FIG. 2, may code a motion vector using the inter prediction block merging tool also referred to as merge mode. Using merge mode, the encoder may reuse the same motion information of a neighboring block for inter prediction of a current block. Because the same motion information of a neighboring block is used, no MVD needs to be signaled and the signaling overhead for signaling the motion information of the current block may be small in size. Similar to AMVP, both the encoder and decoder may generate a candidate list of motion information from neighboring blocks of the current block. The encoder may then determine to use (or inherit) the motion information of one neighboring block's motion information in the candidate list for predicting the motion information of the current block being coded. The encoder may signal, in the bit stream, an indication of the determined motion information from the candidate list. For example, the encoder may signal an index pointing into the list of candidate motion information to indicate the determined motion information.

In HEVC and VVC, the list of candidate motion information for merge mode may comprise up to four spatial merge candidates that are derived from the five spatial neighboring blocks used in AMVP as shown in FIG. 15A, one temporal merge candidate derived from two temporal, co-located blocks used in AMVP as shown in FIG. 15B, and additional merge candidates including bi-predictive candidates and zero motion vector candidates.

It should be noted that inter prediction may be performed in other ways and variants than those described above. For example, motion information prediction techniques other than AMVP and merge mode are possible. In addition, although the description above was primarily made with respect to inter prediction modes in HEVC and VVC, it will be understood that the techniques of the present disclosure described above and further below may be applied to other inter prediction modes, including those of other video coding standards like VP8, VP9, AV1, and the like. In addition, history based motion vector prediction (HMVP), combined intra/inter prediction mode (CIIP), and merge mode with motion vector difference (MMVD) as described in VVC may also be performed and are within the scope of the present disclosure.

In inter prediction, a block matching technique may be applied to determine a reference block in a different picture than the current block being encoded. Block matching techniques have also been applied to determine a reference block in the same picture as a current block being encoded. However, it has been determined that for camera-captured videos, a reference block in the same picture as the current block determined using block matching may often not accurately predict the current block. For screen content video this is generally not the case. Screen content video may include, for example, computer generated text, graphics, and animation. Within screen content, there is often repeated patterns (e.g., repeated patterns of text and graphics) within the same picture. Therefore, a block matching technique applied to determine a reference block in the same picture as a current block being encoded may provide efficient compression for screen content video.

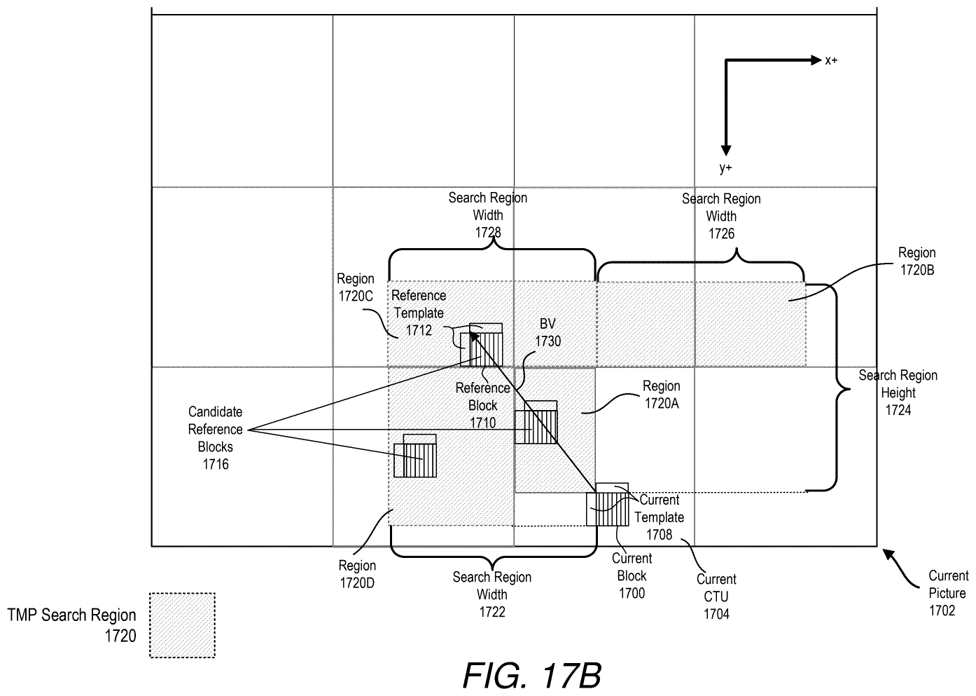

HEVC and VVC both include a prediction technique to exploit the correlation between blocks of samples within the same picture of screen content video. This technique is referred to as intra block copy (IBC) or current picture referencing (CPR). Similar to inter prediction, an encoder may apply a block matching technique to determine a displacement vector (referred to as a block vector (BV)) that indicates the relative displacement from the current block to a reference block (or intra block compensated prediction) that “best matches” the current block. The encoder may determine the best matching reference block from blocks tested during a searching process similar to inter prediction. The encoder may determine that a reference block is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), sum of absolute transformed differences (SATD), or difference determined based on a hash function) between the prediction samples of the reference block and the original samples of the current block. A reference block may correspond to prior decoded blocks of samples of the current picture. The reference block may comprise decoded blocks of samples of the current picture prior to being processed by in-loop filtering operations, like deblocking or SAO filtering. FIG. 16 illustrates an example of IBC applied for screen content. The rectangular portions with arrows beginning at their boundaries are current blocks being encoded and the rectangular portions that the arrows point to are the reference blocks for predicting the current blocks.

Once a reference block is determined and/or generated for a current block using IBC, the encoder may determine a difference (e.g., a corresponding sample-by-sample difference) between the reference block and the current block. The difference may be referred to as a prediction error or residual. The encoder may then store and/or signal in a bitstream the prediction error and the related prediction information for decoding or other forms of consumption. The prediction information may include a BV. In other instances, the prediction information may include an indication of the BV. A decoder, such as decoder 300 in FIG. 3, may decode the current block by determining and/or generating the reference block, which forms the prediction of the current block, using the prediction information and combining the prediction with the prediction error.

In HEVC, VVC, and other video compression schemes, a BV may be predictively coded before being stored or signaled in a bit stream. The BV for a current block may be predictively coded based on the BV of neighboring blocks of the current block. For example, an encoder may predictively code a BV using the merge mode as explained above for inter prediction or a similar technique as AMVP also explained above for inter prediction. The technique similar to AMVP may be referred to as BV prediction and difference coding.

For BV prediction and difference coding, an encoder, such as encoder 200 in FIG. 2, may code a BV as a difference between the BV of a current block being coded and a BV predictor (BVP). An encoder may select the BVP from a list of candidate BVPs. The candidate BVPs may come from previously decoded BVs of neighboring blocks of the current block in the current picture. Both the encoder and decoder may generate or determine the list of candidate BVPs.

After the encoder selects a BVP from the list of candidate BVPs, the encoder may signal, in a bitstream, an indication of the selected BVP and a BV difference (BVD). The encoder may indicate the selected BVP in the bitstream by an index pointing into the list of candidate BVPs. The BVD may be calculated based on the difference between the BV of the current block and the selected BVP. For example, for a BV represented by a horizontal component (BVₓ) and a vertical component (BV_{y}) relative to the position of the current block being coded, the BVD may represented by two components calculated as follows:

$${BVD}_{x} = {BV}_{x} - {BVP}_{x} \qquad ( 17 )$$

$${BVD}_{y} = {BV}_{y} - {BVP}_{y} \qquad ( 18 )$$

where BVDₓ and BVD_{y} respectively represent the horizontal and vertical components of the BVD, and BVPₓ and BVP_{y} respectively represent the horizontal and vertical components of the BVP. A decoder, such as decoder 300 in FIG. 3, may decode the BV by adding the BVD to the BVP indicated in the bitstream. The decoder may then decode the current block by determining and/or generating the reference block, which forms the prediction of the current block, using the decoded BV and combining the prediction with the prediction error.

In HEVC and VVC, the list of candidate BVPs may comprise two candidates referred to as candidates A and B. Candidates A and B may include up to two spatial candidate BVPs derived from five spatial neighboring blocks of the current block being encoded, or one or more of the last two coded BVs when spatial neighboring candidates are not available (e.g., because they are coded in intra or inter mode). The location of the five spatial candidate neighboring blocks relative to a current block being encoded using IBC are the same as those shown in FIG. 15A for inter prediction. The five spatial candidate neighboring blocks are respectively denoted A₀, A₁, B₀, B₁, and B₂. In other implementations, the list of candidate BVPs may include more than two candidate BVPs.

Template Matching Prediction (TMP) is a prediction method that may be reciprocally implemented by the encoder and the decoder. In TMP, a reconstructed region of a current picture may be searched for a reference template of a reference block (RB) that “best matches” a current template of a current block (CB). For example, a plurality of candidate templates may be determined/searched from the reconstructed region from which the reference template may be determined based on template matching (TM) costs calculated for the plurality of candidate templates, as will be further described below. TMP performed on the same picture frame as the current block may be referred to as an Intra-TMP mode or IBC with TMP. The reference template (of the RB) indicates a location of the RB in the reconstructed region, and the RB at this location may be used to predict the CB (by the encoder) or determined the CB (by the decoder). A block vector (BV) may be determined and indicates a displacement from the current block to the reference block. For ease of reference, reference to predicting the CB may refer to operation by the encoder and reference to determining the CB may refer to operation by the decoder.

In some examples, the encoder may encode an indication (e.g., a syntax flag or a signal) indicating that the reference block of the current block was determined by applying TMP. Based on receiving and decoding the indication, the decoder may reciprocally apply TMP to determine the same reference block for the current block. By adding the TMP mode for coding the current block, the BV indicating the reference block with respect to the current block may not be needed to be coded and transmitted by the encoder to the decoder, and thereby reduce information to be coded and increases compression efficiency. In some examples, the BV of the current block may be stored as being associated with the current block to enable the BV of the current block to be used to predictively code a next block, such as in an IBC merge mode or an IBC AMVP mode, as will be further described below.

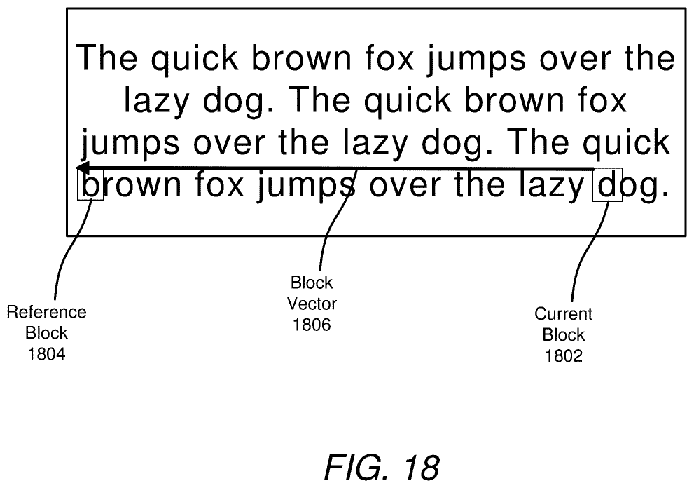

FIG. 17A illustrates an example of a template matching prediction (TMP) mode (also referred to as an Intra-TMP mode) for predicting or determining a current block (CB) 1700, according to some embodiments. CB 1700 comprises a rectangular block of samples, in a picture or video frame of current picture 1702, to be encoded by the encoder or decoded by the decoder. To perform TMP to determine a reference block (RB) 1710 for CB 1700, a coder (e.g., the encoder or the decoder) may determine or construct a current template 1708 of CB 1700. The coder may determine or construct current template 1708 based on samples in a reconstructed region. In an example, current template 1708 may comprise samples in the reconstructed region that are adjacent to the samples of CB 1700. For example, current template 1708 may comprise samples in the reconstructed region to the left and/or above CB 1700. Block vector (BV) 1730 indicates a displacement from CB 1700 to the determined RB 1710.

After determining or constructing current template 1708 of CB 1700, the coder may search a TMP search region 1706 (also referred to as TMP reference region herein) for a reference template 1712 of a reference block (RB) (e.g., RB 1710) that is determined to “best match” current template 1708 of CB 1700. For example, the coder may determine a plurality of candidate templates corresponding to a plurality of respective candidate reference blocks (RBs) 1714, from which reference template 1712 and reference block (RB) 1710 may be determined. As shown in FIG. 17A, the candidate templates of candidate reference blocks 1714 match current template 1708 in shape, orientation, and size.

In some examples, the coder may search TMP search region 1706 for a candidate template of a candidate RB that best matches current template 1708 by determining a cost between current template 1708 and each of the candidate templates of candidate reference blocks 1714 in TMP search region 1706. In an example, the cost may be based on a difference (e.g., sum of squared differences (SSD), sum of absolute differences (SAD), sum of absolute transformed differences (SATD), or difference determined based on a hash function) between a candidate template of a candidate RB and current template 1708. In the example illustrated in FIG. 17A, reference template 1712 of RB 1710 is determined to best match current template 1708 (e.g., based on the cost between reference template 1712 and current template 1708). A Block Vector (BV) may indicate the displacement of an RB (e.g., RB 1710) relative to a CB (e.g., CB 1700).

After determining reference template 1712 of RB 1710, the coder may use RB 1710 to code CB 1700. For example, an encoder may determine a difference (e.g., a corresponding sample-by-sample difference) between CB 1700 and RB 1710. The difference may be referred to as a prediction error or residual. The encoder may store and/or signal in a bitstream the prediction error or residual for decoding by a decoder.

To perform TMP for determining CB 1700, a decoder may perform the same (or reciprocal) operations as the encoder as described above with respect to FIG. 17A. For example, based on receiving an indication from the encoder that TMP is used to predict CB 1700 (e.g., via a flag), the decoder may similarly determine or construct current template 1708 of CB 1700. After determining or constructing current template 1708, the decoder may further similarly search TMP search region 1706 for a reference template of an RB that is determined to “best match” current template 1708. For example, the decoder may determine reference template 1712 of RB 1710, from candidate reference blocks 1714, as best matching current template 1708. After determining reference template 1712 of RB 1710, the decoder may use RB 1710 (corresponding to reference template 1712) to determine CB 1700. For example, the decoder may combine the residual received from the encoder with RB 1710 to reconstruct CB 1700. Therefore, BV 1730 that indicates RB 1710 may not need to be indicated by the encoder to the decoder to enable the decoder to determine RB 1710.

In some examples, TMP search region 1706 comprises a portion of a reconstructed region of current picture 1702. TMP search region 1706 indicates the regions that the encoder or decoder may search for candidate templates (such as candidate templates of candidate reference blocks 1714) to determine reference template 1712 and corresponding RB 1710. In some examples, TMP search region 1706, may include region 1706A, region 1706B, region 1706C, and region 1706D. Relative to CB 1700, region 1706A (R1) may include a portion of the current CTU, region 1706C (R2) may be the top-left CTU, region 1706B (R3) may be the above CTU, and region 1706D (R4) may be the left CTU. The CTUs are a result of picture partitioning operations described in more detail above. For example, an encoder or decoder may search for a matching template within TMP search region 1706. For example, reference template 1712 of RB 1710 may be determined to best match current template 1708 of CB 1700 based on a SAD cost or some other cost as described above. The decoder may use RB 1710 to predict CB 1700 as described above.

In some examples, the dimensions of TMP search region 1706 (referred to as SearchRange_w, SearchRange_h) may be set proportionally to the dimensions of CB 1700 (referred to as BIkW, BIkH) to have a fixed number of SAD comparisons (or other difference comparisons) per pixel. More specifically, the dimensions of TMP search region 1706 may be calculated as follows:

$$SearchRange\_w = a * BlkW \qquad ( 19 )$$

$$SearchRange\_h = a * BlkH \qquad ( 20 )$$

Where ‘a’ (or alpha) is a constant that controls a gain/complexity trade-off for the encoder or decoder. For example, ‘a’ may be equal to 5. In FIG. 17A, it should further be noted that the dimensions of TMP search region 1706 is illustrated by example and not by limitation. In practical implementation, for example, the dimensions of the regions may vary, and/or one or more of the regions may not be present. In the example illustrated by FIG. 17A, portions of reconstructed region directly above and directly left of CB 1700 may not be available for prediction or determination and may be excluded from TMP search region 1720. For example, this may be because an RB in these portions would overlap with CB 1700, which would be an invalid location for prediction or determination of CB 1700. A similar restriction may also be based on the unavailability of samples because of the sequence order of encoding or decoding, or because the samples may be outside of TMP search region or current picture 1702.

FIG. 17B illustrates an example of a template matching prediction (TMP) mode for predicting or determining a current block (CB) 1700, according to some embodiments. In contrast to TMP search region 1706 in FIG. 17A, TMP search region 1720 may not necessarily encompass one or more CTUs, as described above. For example, the dimensions of TMP search region 1720 may be based on fixed multiples of the dimensions of CB 1700, as shown in (19) and (20). For example, search region height 1724 may correspond to (20) and each of search region width 1722, search region width 1726, and search region width 1728 may correspond to (19). TMP search region 1720 may include region 1720A (R1), region 1720B (R3), region 1720C (R2), and region 1720D (R4). As shown, one or more regions (or portions) of TMP search region 1720 may not encompass an entire CTU (e.g., region 1720D) and may be across multiple CTUs (e.g., region 1720B and region 1720C). In the example of FIG. 17B, the same reference template 1712 of RB 1710, from candidate reference blocks 1716, may have been determined as best matching current template 1708. Similarly, BV 1730 indicates a displacement from CB 1700 to RB 1710.

Referring back to FIG. 16, in IBC mode applied for screen content, a reference block (RB) may be determined as a “best matching” reference block to a current block. For example, the arrows correspond to block vectors (BVs) that indicate respective displacements from respective current blocks (CBs) to respective reference blocks that best match the respective current blocks. In the examples shown in FIG. 16, the reference blocks match the respective current blocks and the calculated residuals would be small, if not zero. However, often, video content may be more efficiently encoded by considering symmetry properties. For example, it has been observed that symmetry is often present in video content, especially in text character regions and computer generated graphics in screen content video.

In existing technologies, a Reconstruction-Reordered intra block copy IBC (RRIBC) mode (e.g., also referred to as IBC-Mirror Mode) was introduced for screen content video coding to take advantage of symmetry within video content to further improve the coding efficiency of IBC. For example, the RRIBC mode was adopted into the Enhanced Compression Model (ECM) software algorithm that is currently under coordinated exploration study by the Joint Video Exploration Team (JVET) of ITU-T Video Coding Experts Group (VCEG) and ISO/IEC MPEG as a potential enhanced video coding technology beyond the capabilities of VVC. In some examples, the RRIBC mode may be signaled based on IBC mode with an indication (or flag) indicating whether flipping is applied and if flipping is applied, further signaling an indication (or flag) indication a direction of flipping.

In some embodiments, when the RRIBC mode is indicated for encoding a current block, a residual for the current block may be calculated based on samples of a reference block (e.g., corresponding to an original reference block being encoded and decoded to form a reconstructed block) being flipped relative to the current block according to a flip direction indicated for the current block. In an example, at the encoder side, the current block (to be predicted) may be flipped before matching and residual calculation, while the reference block (used to predict the current block) may be derived without flipping. Similarly, at the decoder side, the current block (that was flipped at the encoder) may be determined based on the reference block and residual information, then flipped back to restore the original orientation of the current block before being flipped at the encoder side. In another example, instead of the current block being flipped, the reference block may be flipped instead such that the reference block is flipped to encode the current block (at the encoder) and flipped back (at the decoder) to restore the original orientation of the reference block at the encoder. As described in this specification, reference to flipping the current block may alternatively refer to flipping the reference block and not the current block such that the reference block and the current block are flipped in the direction with respect to each other.

In an example, in the RRIBC mode, the flip direction may include one of a horizontal direction or a vertical direction for RRIBC coded blocks. In an embodiment, for a current block coded in the RRIBC mode (e.g., an IBC advanced motion vector prediction (AMVP) coded block), a first indication (e.g., a first syntax flag) may indicate/signal whether to use flipping (e.g., also referred to as mirror flipping) to encode/decode the current block. Additionally, for the current block, a second indication (e.g., a second syntax flag) may indicate/signal the direction for flipping (e.g., vertical or horizontal). For IBC merge, the flip direction may be inherited from neighboring blocks, without syntax signaling. In an example, for RRIBC, flipping of a current block (or a reference block in an alternative embodiment) in a horizontal and a vertical direction can be represented in (21) and (22), respectively:

$$Reference ( x , y ) = Sample ( w - 1 - x , y ) \qquad ( 21 )$$

$$Reference ( x , y ) = Sample ( x , h - 1 - y ) \qquad ( 22 )$$

where w and h are the width and height of a current block, respectively. Sample(x,y) may indicate a sample value located in (x,y). Reference(x,y) may indicate a corresponding reference sample value after flipping. In other words, for horizontal flipping, (21) shows that the current block is flipped in the horizontal direction by sampling from right to left. Similarly, for vertical flipping, (22) shows that the current block is flipped in the vertical direction by sampling the current block from down to up.

Considering the horizontal or vertical symmetry, the current block and the reference block are normally aligned horizontally or vertically, respectively. Therefore, in an example, based on the RRIBC mode and a flipping direction, the reference block may be determined from a reference region (including candidate reference blocks) aligned in the same flipping direction, as will be further described below. As a result, when flipping in a horizontal direction is applied/indicated, the vertical component (BV_{y}) of the BV (indicating a displacement from the current block to the reference block) may not need to be signaled because it may be inferred to be equal to 0. Similarly, when flipping in a vertical direction is applied/indicated, the horizontal component (BVₓ) of the BV may not need to be signaled because it may be inferred to be equal to 0. In other words, in an example, only one component, aligned with the direction for flipping, of the BV may be encoded and signaled for the current block.

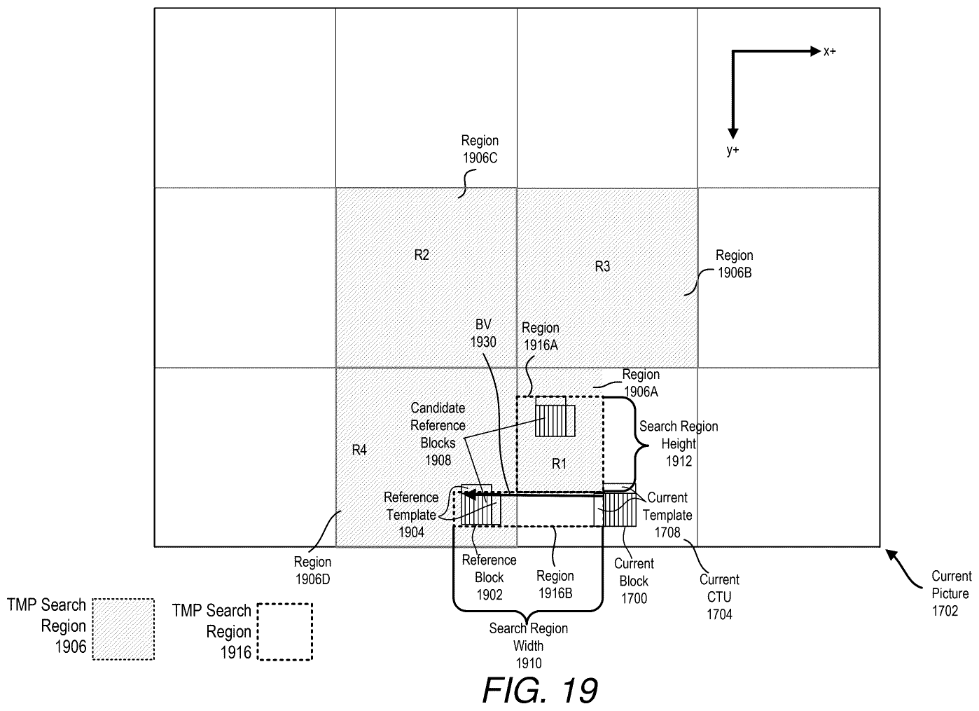

FIG. 18 illustrates an example of RRIBC mode applied for screen content to utilize symmetry within text regions to increase efficiency for coding video content. Similar to an encoder described in FIG. 16 (e.g., encoder 114 of FIG. 1), the encoder may determine, for example, that a reference block 1804, based on applying horizontal flipping, is the best matching reference block for a current block 1802. For example, the encoder may select reference block 1804 as the “best matching” reference block based on one or more cost criterion, such as a rate-distortion criterion, as described above. The one or more cost criterion may be applied to reference block 1804 that is flipped in the horizontal direction relative to current block 1802. For example, current block 1802 may be flipped before the one or more cost criterion are applied to determine reference block 1804. Note that for flipping in the horizontal direction, reference block 1804 is located in a reference region that is in horizontal alignment with current block 1802, as will be further described below. Therefore, a block vector (BV) 1806, indicating a displacement between current block 1802 and reference block 1804, may be represented as only a horizontal component (BVₓ) of BV 1806 because due to the constraints on possible locations of reference blocks, the vertical component of BV 1806 will be equal to 0 when horizontal flipping is indicated/applied.

For a current block coded in IBC mode, a BV for the current block may be constrained to indicate a relative displacement from the current block to a reference block within an IBC reference region. In some examples, a BVP used to predicatively code a BV may be similarly constrained. This is because a BVP may be derived from a BV of a spatially neighboring block of the current block or a prior coded BV as explained above. Based on the BVP, a BVD may be determined as a difference between the BV and the BVP. This BVD may be encoded and transmitted along with an indication of the selected BVP in a bitstream to enable decoding of the current block, as described above. With the introduction of RRIBC, a reference block (that is flipped in a direction relative to the current block) may be constrained to (i.e., selected from) an RRIBC reference region, corresponding to the direction, that is a subset or within the IBC reference region. Like in the IBC mode, the BVP may be used to predicatively code a BV, for a current block, indicating a relative displacement from the current block to a reference block within the a reference region (e.g., RRIBC region). Based on the RRIBC mode being indicated and based on a direction for flipping a reference block relative to a current block, the reference region (e.g., an RRIBC reference region) can be determined that corresponds to the direction for flipping. The reference region indicates a region within a picture frame from which the reference block may be selected (e.g., after flipping of the CB).

In existing technologies, as described above, a TMP mode may be applied to a current block to determine a reference block in IBC. For example, reference templates, corresponding to candidate reference blocks, may be searched that “best” matches a current template of the current block to determine the reference block for coding the current block. In this TMP mode, the reference templates match the current template in size, shape, and orientation. However, this TMP mode searches for the reference block that best predicts the current block and does not consider horizontal or vertical symmetry of content within a picture or video frame.

In some embodiments, to take advantage of horizontal or vertical symmetry of content, the TMP mode can be enhanced by considering one or more other template types when searching for a reference block. For example, the TMP mode may use candidate templates that are flipped in a direction with respect to the current template. These candidate templates may match the current template in shape and size, but not in orientation. For example, these candidate templates may match the current template, after flipping in the direction, in shape, size, and orientation. In some examples, in contrast to the reference/search region in RRIBC mode, a TMP search region for TMP mode using flipped templates may be extended to search for candidate refence blocks that are not aligned in the same row or column as the current block. For example, since the TMP technique may have a smaller computation cost as compared to directly searching candidate reference blocks, extending the TMP search region may increase compression, by finding a reference block that better matches the current block, with a small increase in a processing and/or complexity cost.

In some embodiments, a BV may indicate a displacement from the current block to the determined reference block. This BV of the current block may be stored as being associated with the current block to enable the BV of the current block to be used to predictively code a next block, such as in an IBC merge mode or an IBC AMVP mode, as will be further described below.

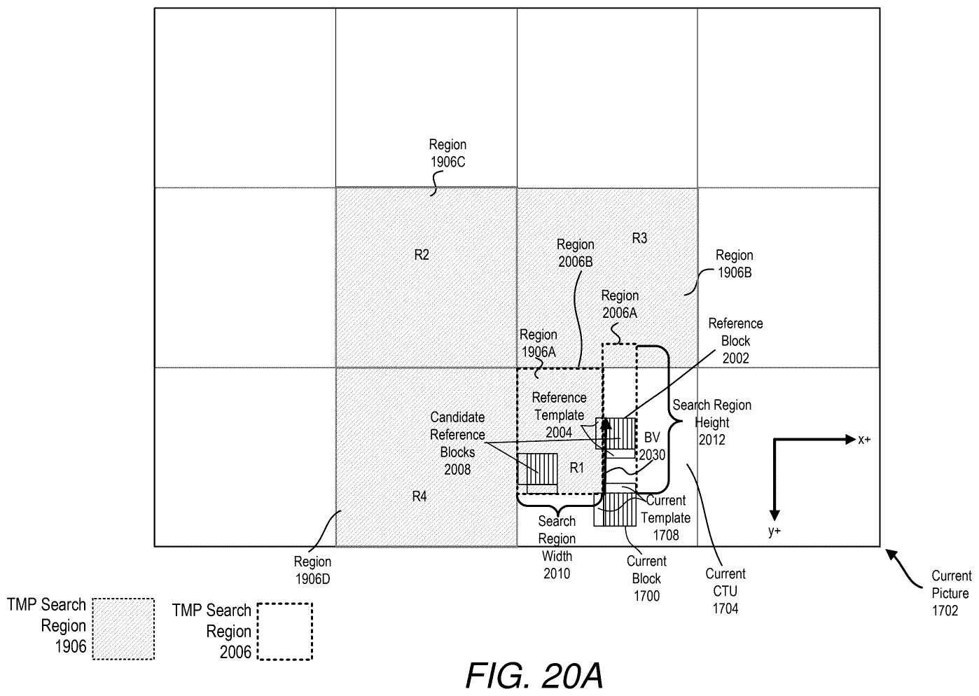

FIG. 19 illustrates an example a TMP mode using candidate templates flipped in a horizontal direction, according to some embodiments. For ease of comparison, FIG. 19 shows a TMP search region 1906 including regions 1906A-D. TMP search region 1906 may be TMP search region 1706 or TMP search region 1720. In some embodiments, the TMP mode (such as that shown in FIG. 17A) may be enhanced by including other types of candidate templates. For example, candidate templates of candidate RBs 1908 may be determined from TMP search region 1916 to determine TM costs, similarly as described with respect to candidate templates in TMP search region 1706, to determine a best matching candidate template as a reference template. For example, reference template 1904 of reference block 1902 may be determined to best match current template 1708. As shown, block vector (BV) 1930 indicates the displacement from CB 1700 to reference block 1902 determined using the TMP mode using flipped candidate templates. Similar to a TMP mode, such as that shown in FIG. 17A and FIG. 17B, an encoder may signal the TMP mode using candidate templates flipped in the horizontal direction to enable the decoder to reciprocally perform TMP to determine reference block 1902 also determined by the encoder. Therefore, B V 1930 may not need to be signaled to the decoder and increases compression efficiency of CB 1700.

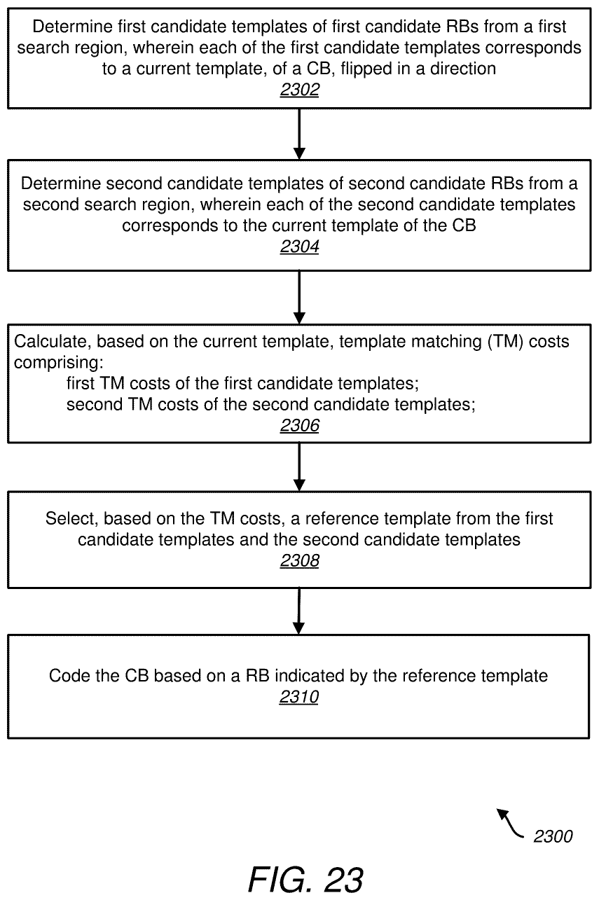

In some examples, TMP search region 1916 may include region 1916A and region 1916B, as shown and further described in FIG. 23, which may be based on search region width 1910 and search region height 1912. In some examples, candidate templates of candidate RBs 1908 may be flipped in a horizontal direction with respect to current template 1708. In some examples, search region width 1910 and search region height 1912 may be based on a fixed multiple of a width and a height of CB 1700, as described above regarding (19) and (20). In some examples, in contrast to the search regions for RRIBC for horizontal flipping, TMP search region 1916 includes search region 1916A that is not aligned with CB 1700 in the direction of flipping.

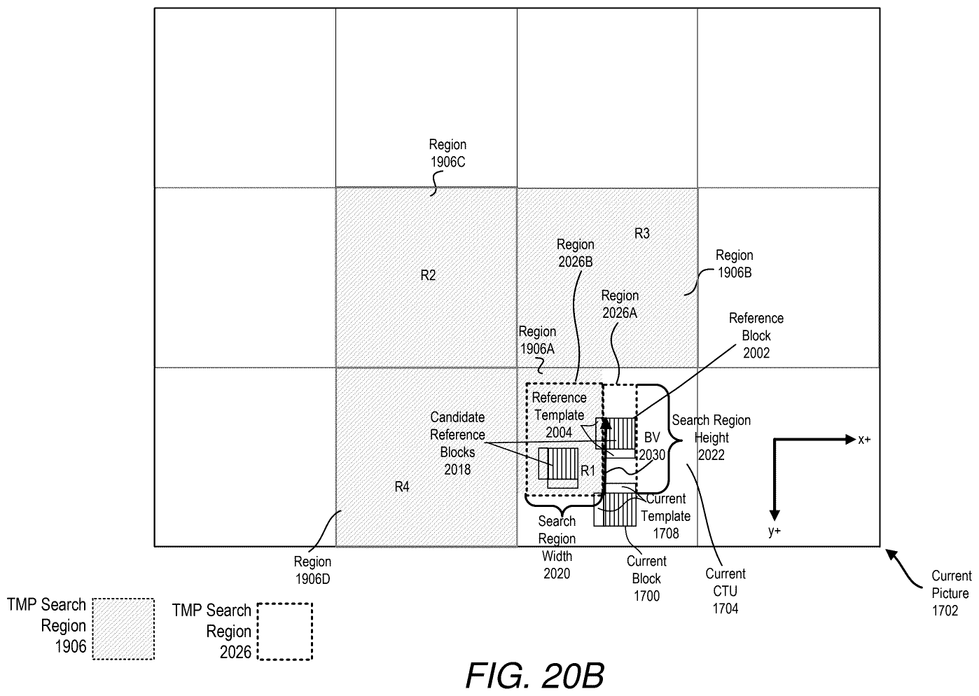

FIG. 20A illustrates an example a TMP mode using candidate templates flipped in a vertical direction, according to some embodiments. In some embodiments, the TMP mode (such as that shown in FIG. 17A) may be enhanced by including other types of candidate templates. For example, candidate templates of candidate reference blocks (RBs) 2008 may be determined from TMP search region 2006 to determine TM costs, similarly as described with respect to candidate templates in TMP search region 1706, to determine a best matching candidate template as a reference template. For example, reference template 2004 of reference block 2002 may be determined to best match current template 1708. As shown, block vector (BV) 2030 indicates the displacement from CB 1700 to reference block 2002 determined using the TMP mode using flipped candidate templates. Similar to a TMP mode, such as that shown in FIG. 17A and FIG. 17B, an encoder may signal the TMP mode using candidate templates flipped in the vertical direction to enable the decoder to reciprocally perform TMP to determine reference block 2002 also determined by the encoder. Therefore, BV 2030 may not need to be signaled to the decoder and increases compression efficiency of CB 1700.

In some examples, TMP search region 2006 may include region 2006A and region 2006B, as shown and further described in FIG. 23, which may be based on search region width 2010 and search region height 2012. In some examples, candidate templates of candidate RBs 2008 may be flipped in a vertical direction with respect to current template 1708. In some examples, search region width 2010 and search region height 2012 may be based on a fixed multiple of a width and a height of CB 1700, as described above regarding (19) and (20). In some examples, in contrast to the search regions for RRIBC for vertical flipping, TMP search region 2006 includes search region 2006A that is not aligned with CB 1700 in the direction of flipping.

FIG. 20B illustrates an example a TMP mode using candidate templates flipped in a vertical direction, according to some embodiments. FIG. 20B illustrates a TMP search region 2026 for candidate templates flipped in a vertical direction relative to current template 1708. As shown, the same reference template 2004 of reference block 2002 may be determined as that in FIG. 20A. Compared to TMP search region 2006 in FIG. 20A, TMP search region 2026 shows that TMP search region 2026 includes region 2026A and region 2026B. In some examples, depending on search region width 2020 and search region height 2022, region 2006B may not necessarily intersect an upper boundary and/or a left boundary of current CTU 1704, as will be further described below in FIG. 23. Similarly, depending on search region width 1910 and search region height 1912, the TMP search region 1916 in FIG. 19 may not necessarily intersect an upper boundary and/or a left boundary of current CTU 1704, as will be further described below in FIG. 23.

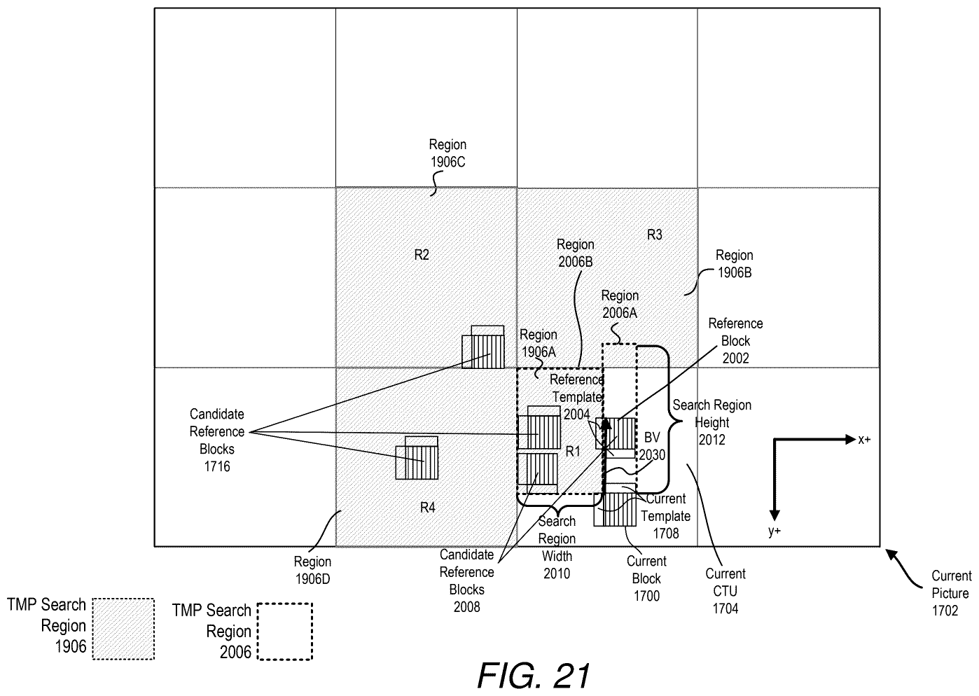

FIG. 21 illustrates an example of a TMP mode (also referred to as a TM mode or an Intra-TMP mode) using a plurality of types of candidate templates, according to some embodiments. For example, FIG. 21 shows that candidate templates of candidate reference blocks 1716, from TMP search region 1906, and candidate templates of candidate RBs 2008, from TMP search region 2006, may be determined to determine a best matching candidate template as a reference template (e.g., reference template 2004). For illustration purposes, FIG. 21 shows the types of candidate templates including candidate templates without flipping and candidate templates flipped in the vertical direction, as described with respect to FIG. 20A and FIG. 20B. However, other types of candidate templates may be searched instead such as candidate templates flipped in the horizontal direction, as described in FIG. 19. In some examples, a plurality of types of candidate templates may include candidate templates flipped in a horizontal direction and candidate templates flipped in a vertical direction.

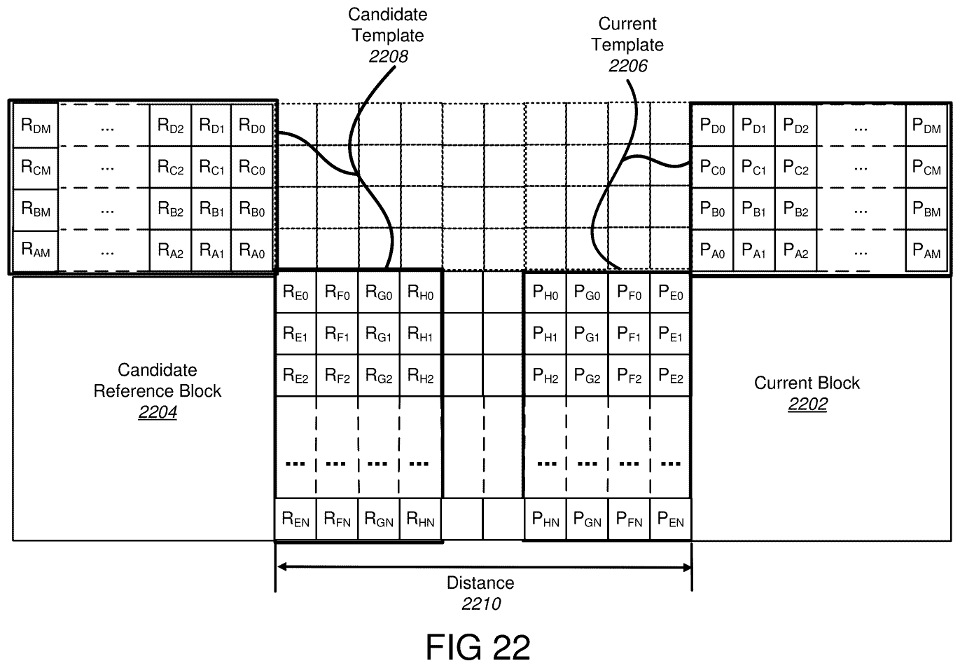

FIG. 22 illustrates an example of template matching for TMP, according to some embodiments. In some embodiments, the shape of the current template is defined relative to the current block and may adjoin or surround the current block, but is not required to be located immediately adjacent to the current block. The shape may include a plurality of samples in a reconstructed portion of the picture frame. For example, the plurality of samples may include a plurality of reference pixels that have been reconstructed (e.g., encoded and then decoded) and are distributed along at least one of two adjacent sides (e.g., a left side and an upper side) of the current block. The plurality of reference pixels of the current block may also be referred to as first reference pixels that are close to the current block. A pixel close to the current block may refer to a distance between the pixel and a side of the current block that is closest to the pixel is less than a threshold. The distance between the pixel and the side of the coding block may be defined by a number or count of pixels between the pixel and the side of the current block. The threshold may be equal to 1, or 2, or 3, or 4, etc.

In some examples, the current template may include a first portion and a second portion, where the first portion includes a number of rows of (neighboring reconstructed) samples above the current block, and the second portion includes a number of columns of (neighboring reconstructed) samples to the left of the current block. It is to be understood that other types of shapes are possible that include a set of reconstructed samples defined relative to the current block. In some examples, a candidate template may be compared against the current template by comparing a pair of samples from the candidate template and the current template, respectively, where the pair of samples are iteratively in a mirrored manner depending on the direction of flipping.

For example, when the direction is horizontal flipping and for the current template with a size of the template Tₛ, position (x_{c},y_{c}) being the top-left corner of a current block of size W×H and position (x_{ref},y_{ref}) being the top-left corner of a reference block, a pair of samples for the second portion of the current template and a corresponding portion of the reference template is defined as {(x_{c}−1−j,y_{c}+i), (x_{ref}+W+j,y_{ref}+i)}, where j∈[0,Tₛ), i∈[0,W). For example, the size Tₛ may be a width of the second portion. In some examples, samples in the first portion of the current template may be similarly compared to samples in a corresponding portion of the candidate template. For example, a pair of samples for the first portion of the current template and the corresponding portion of the reference template is defined as {(x_{c}+j,y_{c}−1−i),(x_{ref}+W−1−j,y_{ref}−1−i)}, where j∈[0,W), i∈[0,T). Here, the size Tₛ may be a height of the first portion.

For example, when the direction is vertical flipping and for the current template with a size of the template Tₛ, position (x_{c},y_{c}) being the top-left corner of a current block of size W×H and position (x_{ref},y_{ref}) being the top-left corner of a reference block, a pair of samples for the second portion of the current template and a corresponding portion of the reference template is defined as {(x_{c}−1−j,y_{c}+i), (x_{ref}−1−j,y_{ref}+H−1−i)}, where j∈[0,Tₛ),i∈[0,H). For example, the size Tₛ may be a width of the second portion. In some examples, samples in the first portion of the current template may be similarly compared to samples in a corresponding portion of the candidate template. For example, a pair of samples for the first portion of the current template and the corresponding portion of the reference template is defined as {(x_{c}+j,y_{c}−1−i),(x_{ref}+j,y_{ref}+H+i)}, where j∈[0,W), i∈[0,T). Here, the size Tₛ may be a height of the first portion.

FIG. 22 illustrates an example of template matching between a current template 2206, of a current block 2202, and a candidate template 2208 of a reference block (RB) candidate 2204A, according to some embodiments. As shown in FIG. 22, samples P_{idx} of current template 2206 of a current block 2202 (to be predicted) and samples R_{idx} of candidate template 2208 of a RB candidate 2204 are shown for the case of horizontal flipping. To compare samples of these templates to calculate a matching/comparison cost, a difference between pairs of samples may be calculated as: Σ|P_{idx}−R_{idx}|, idx={idx_{HOR},idx_{VER}}; where idx_{HOR} {D_{HOR},n}, D∈{“A”, “B”, “C”, “D” }, n∈[0,cbWidth−1]; and idx_{VER} {D_{VER},m}, D∈{“E”, “F”, “G”, “H” },m∈[0,cbHeight−1]. In some embodiments, how portions of current template 2206 and candidate template 2208 are to be compared is based on a distance 2210 as shown. The comparisons shown in FIG. 22 may be applied when distance 2210 is greater or equal to twice the size of the left portion of current template 2206, e.g., 4.

FIG. 23 illustrates a flowchart 2300 of a method for using template matching prediction (TMP) with multiple template types to code (e.g., encode or decoded) a current block (CB), according to some embodiments. For example, the CB may be coded in a TMP mode using at least two template types. For example, the CB may be coded in a TMP mode that uses candidate templates that are flipped in a direction relative to a current template of the CB, as further described below. The method of flowchart 2300 may be implemented by a coder such as an encoder (e.g., encoder 200 in FIG. 2) or a decoder (e.g., decoder 300 in FIG. 3). In other words, the method shown in FIG. 23 include reciprocal operations that both the encoder and the decoder may perform to respectively encode and the decode the CB, as further described below.

Some of the steps of flowchart 2300 may not necessarily be in the same sequence, as would be understood by a skilled person in the art.

At block 2302, first candidate templates of first candidate reference blocks (RBs), from a first search region (which may alternatively be referred to as a first reference region), are determined. Each of the first candidate templates corresponds to a current template, of a CB, flipped in a direction.

In some examples, the current template is defined relative to the CB. The current template may include a set of reconstructed samples neighboring the CB such as reconstructed pixels. In some examples, the current template may have an “L” shape. For example, the current template may include: a first portion comprising a number of rows (e.g., 1, 2, 4, etc.) of samples above the CB, and a second portion comprising a number of columns (e.g., 1, 2, 4, etc.) of samples to the left of the CB. In an example, the first portion may be adjacent to the top side of the CB and the second portion may be adjacent to the left side of the CB. In an example, the rows match the CB in width and the columns match the CB in height.

In some examples, the first candidate templates are defined relative to the respective first RB candidates. In some examples, each of the first candidate templates corresponding to the current template flipped in the direction includes each of the first candidate templates matching the current template, after flipping in the direction, in shape and orientation. Each of the first candidate templates may further match the flipped current template in size. In some examples, geometry of each of the first candidate templates differs from the flipped current template only in position (or location) in a picture frame.

In some examples, based on the direction being horizontal, each of the first candidate template includes: the number of rows of samples above a respective candidate template, and the number of columns of samples to the right of the respective candidate template. Similarly, based on the direction being vertical, each of the first candidate template may include: the number of rows of samples below the respective first candidate template, and the number of columns of samples to the left of the respective first candidate template.

At block 2304, second candidate templates of second candidate RBs, from a second search region (which may alternatively be referred to as a second reference region), are determined. Each of the second candidate templates corresponds to the current template of the CB. For example, each of the second candidate templates may correspond to the current template without flipping and/or other transformation except translation.

In some examples, the second candidate templates are defined relative to the respective second RB candidates. In some examples, each of the second candidate templates corresponding to the current template includes each of the second candidate templates matching the current template in shape and orientation. Each of the second candidate templates may further match the current template in size. In some examples, geometry of each of the second candidate templates differs from the current template only in position (or location) in a picture frame.

In some examples, each of the second candidate template includes: the number of rows of samples above a respective candidate template, and the number of columns of samples to the left of the respective candidate template.

In some examples, the first search region and the second search region are each portions of a picture frame (alternatively referred to as a video frame) of the CB. Each portion correspond to reconstructed portions (when performed by the encoder) or decoded portions (when performed by the decoder) of the CB. The current template, each of the first candidate templates, and each of the second candidate templates may include a respective set of reconstructed (or decoded) samples.

In some examples, the first search region is different from the second search region. For example, the second search region includes portions of a current coding tree (CTU), of the CB, not included (or excluded from) in the first search region, as shown in examples of FIG. 19, FIG. 20A, and/or FIG. 20B. In some examples, the second search region is defined relative to a position of the CB (or to a current coding tree unit (CTU) of the CB). For example, as described with respect to FIG. 17A, the second search region includes: a first coding tree unit (CTU) above and adjacent to a current CTU in which the CB is located; a second CTU to the left and adjacent to the current CTU; a third CTU above and to the left of the current CTU, wherein the third CTU is adjacent to the first CTU and the second CTU; and a portion, of the current CTU, above and to the left of the CB. In other examples, the second search region may include a plurality of rectangles with dimensions determined based on dimensions of the CB.

In some examples, the first search region includes: a first rectangular region located above and to the left of the CB; and a second rectangular region located above or to the left of the CB depending on the direction. The first rectangular region may be within a current CTU of the CB. In some examples, the second search region may overlap the first search region in at least the first rectangular region of the first search region. As shown in the examples of FIGS. 19-21, the first rectangular region may have a lower right corner that intersects (or meets) an upper left corner of the CB. In some examples, as described in FIGS. 19-21, the first rectangular region includes a first width and a first height that may be based on a width and a height of the CB, respectively. For example, based on the direction being horizontal, the first rectangular region may have a height that is a predefined multiple of a height of the CB. In some examples, based on the direction being horizontal, the height of the first rectangular region may be the smaller of the predefined multiple of the height of the CB or a distance between the top sides (also referred to as upper boundaries) of the CB and the current CTU of the CB. In some examples, based on the direction being horizontal, the first rectangular region may have a width that is the smaller of a predefined multiple of a width of the CB and a distance between the left sides (also referred to as left boundaries) of the CB and the current CTU of the CB. In some examples, the width of the first rectangular region may be the distance between the left sides of the CB and the current CTU.

Similarly, based on the direction being vertical, the first rectangular region may have a width that is a predefined multiple of a width of the CB. In some examples, based on the direction being vertical, the width of the first rectangular region may be the smaller of the predefined multiple of the width of the CB or a distance between the left sides (or left boundaries) of the CB and the CTU of the CB. In some examples, based on the direction being vertical, the first rectangular region may have a height that is the smaller of a predefined multiple of a height of the CB and a distance between the top sides (also referred to upper boundaries) of the CB and the current CTU. In some examples, the height of the first rectangular region may be the distance between the tops sides of the CB and the current CTU.

In some examples, the second rectangular region includes a second width and a second height that are based on a width and a height of the CB, respectively. For example, as shown in FIG. 19, based on the direction being horizontal, the second rectangular region may be adjacent to and to the left of the CB. For example, the second rectangular region may include a second height that is the same as a height of the CB and includes a second width that is based on a width of the CB.

For example, as shown in FIG. 20A and/or FIG. 20B, based on the direction being vertical, the second rectangular region may be adjacent to and above the CB. For example, the second rectangular region may include a second width that is the same as a width of the CB and includes a second height that is based on a height of the CB.

At block 2306, template matching (TM) costs are calculated based on the current template, wherein the TM costs include: first TM costs of the first candidate templates, and second TM costs of the second candidate templates. For example, the first TM costs are of the first candidate templates, respectively, and the second TM costs are of the second candidate templates, respectively.

In some examples, calculating the TM costs includes comparing samples in each of the first candidate templates against corresponding samples, in the current template, flipped in the direction to calculate the respective first TM costs. In some examples, each of the first TM costs may be based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), or sum of absolute transformed differences (SATD)) between the prediction/reference samples of each of the first candidate template and the samples, of the current template, flipped in the direction.

In some examples, calculating the TM costs includes comparing samples in each of the second candidate templates against corresponding samples, in the current template, to calculate the respective second TM costs. Similar to calculating costs of the first TM costs, each of the second TM costs may be based on the one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), or sum of absolute transformed differences (SATD)) between the prediction/reference samples of each of the second candidate template and the corresponding samples of the current template.

At block 2308, based on the TM costs, a reference template is selected from (e.g., at least) the first candidate templates and the second candidate templates. In some examples, the reference template may be a candidate template selected, from at least the first candidate templates and the second candidate templates, as having a smallest TM cost among the TM costs. In other words, the reference template may be determined, from tested candidate templates, as a “best matching” template to the reference template, which means a residual between the RB (indicated by the reference template) and the CB (after flipping in the direction if the reference template is from the first candidate templates) may be reduced compared to using other block indicated by other candidate templates.

At block 2310, the CB is coded based on a reference block (RB) indicated by the reference template. For example, the CB may be predicted (by an encoder) or determined (by a decoder) based on the RB. The RB may be a block from which the reference template is defined.

In some embodiments, at the encoder, the RB is used to predict the CB and the coding the CB includes encoding the CB based on the RB. In some examples, encoding the CB may include determining, based on whether the reference template is from the first candidate templates or the second candidate templates, whether to flip the CB in the direction before determining a residual of the CB. Then, the residual of the CB may be determined based on: the determining whether to flip the CB, the RB, and the CB. The determined residual (of the CB) may be transmitted in a bitstream. In some examples, based on the reference template being from the first candidate templates, the residual may be determined as a difference between the RB and the CB flipped in the direction. In some examples, based on the reference template being from the second candidate templates, the residual may be determined based on a difference between the RB and the CB.

In some embodiments, at the encoder, coding the CB may include transmitting, in a bitstream, an indication of the CB being encoded in a template matching prediction (TMP) mode that uses multiple types of candidate templates, e.g., using candidate templates that are flipped in the direction relative to the current template. The determination of the first candidate templates (at block 2302) and the determination the second candidate templates (at block 2304) may be in response to the encoder being in (or operating under) this TMP mode (also referred to herein as reconstructed-reordered TMP mode or RR-TMP mode).

In some examples, encoding the CB may include: based on the reference template being from the first candidate templates, determining a residual based on a difference between the RB and the CB flipped in the direction, and based on the reference template being from the second candidate templates, determining the residual based on a difference between the RB and the CB. Then, the residual of the CB may be transmitted in the bitstream.

In some embodiments, at the decoder, the RB is used to determine the CB and the coding the CB includes decoding the CB based on the RB. In some examples, decoding the CB may include receiving, from a bitstream, a residual of the CB. A reconstructed block may be determined based on combining the RB with the residual of the CB received from the bitstream. Whether to flip the reconstructed block in the direction may be determined based on whether the reference template is from the first candidate templates or the second candidate templates. For example, based on the reference template being one of (or from) the first candidate templates, the decoder may determine to flip the reconstructed block, and based on the reference template being one of the second candidate templates, the decoder may determine to not flip the reconstructed block. The CB may be decoded based on whether to flip the reconstructed block in the direction.

In some examples, based on the reference template being from the first candidate templates, the decoder may flip the reconstructed block in the direction, and decode the CB based on the flipped reconstructed block. For example, the CB may correspond to the flipped, reconstructed block. In some examples, based on the reference template being from the second candidate templates, the decoder may decode the CB based on the reconstructed block. For example, the CB may correspond to the reconstructed block (e.g., without further transformations such as flipping, rotation, and/or scaling, etc.).

In some examples, a decoder may receive, in a bitstream, an indication of the CB being encoded in a template matching prediction (TMP) mode that uses multiple types of candidate templates, e.g., using candidate templates that are flipped in the direction relative to the current template. The determination of the first candidate templates (at block 2302) and the determination the second candidate templates (at block 2304) may be in response to the decoder receiving indication of this TMP mode (also referred to herein as reconstructed-reordered TMP mode or RR-TMP mode).

In some examples, a decoder may receive a residual of the CB from a bitstream. Based on the selected/determined reference template being from the first candidate templates, the decoder may decode the CB based on flipping a reconstructed block in the direction, with the reconstructed block being a combination of the RB with the residual of the CB. Based on the reference template being from the second candidate templates, the decoder may decode the CB based on combining the RB with the residual of the CB.

In some embodiments, one or more types of additional candidate templates of corresponding additional candidate RBs may be further determined from which the reference template may be determined, based on TM costs of the additional candidate templates, in addition to the first candidate templates and the second candidate templates. For example, the method of FIG. 23 may further include determining third candidate templates of third candidate RBs from a third search region, with each of the third candidate templates corresponding to the current template flipped in a second direction. The third search region may correspond to the second direction. For example, the direction (associated with the first candidate templates) may be horizontal and the second direction may be vertical or vice versa. In these examples, at block 2306, the TM costs may further include third TM costs of the third candidate templates, which may be similarly calculated based on one or more cost criterion as described above with respect to calculating the first TM costs of the first candidate templates. In these examples, at block 2308, the reference template may be selected, based on the TM costs, from the first candidate templates, the second candidate templates, and the third candidate templates.

It should be further noted that the method discussed above with respect to FIG. 23 may not be limited to candidate templates which are flipped in a direction and may be further extended to include other types of candidate templates which correspond to other transformations performed on the current template, as would be appreciated by a person of ordinary skill in the art based on the present disclosure. For example, at block 2302, instead of each of the first candidate templates corresponding to the current template (of the CB) flipped in a direction, each of the first candidate templates may correspond to the current template (of the CB) with a transformation applied. In some examples, each of the first candidate templates corresponding to the current template with the transformation applied may include each of the first candidate templates matching the current template, after the transformation, in size, shape, and orientation. In an example, the transformation may include a rigid transformation (or isometry) that does not change the size or shape after transformation. The transformation may include one or more of rotation and reflection, and may exclude translation. For example, the transformation may include rotating the current template by a predetermined amount (e.g., degrees, or radians, etc.)

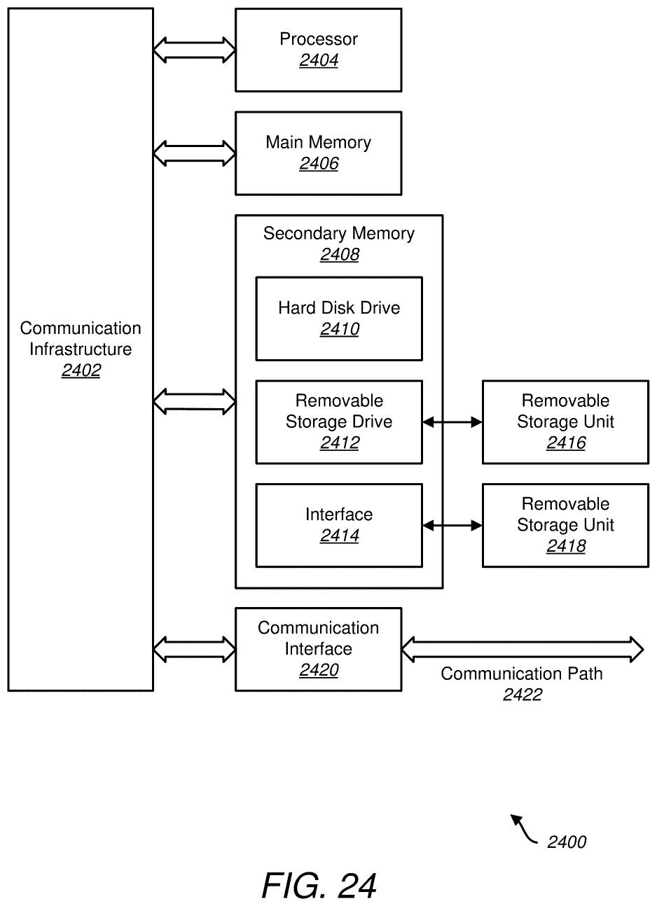

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 2400 is shown in FIG. 24. Blocks depicted in the figures above, such as the blocks in FIGS. 1, 2, and 3, may execute on one or more computer systems 2400. Furthermore, each of the steps of the flowcharts depicted in this disclosure may be implemented on one or more computer systems 2400.

Computer system 2400 includes one or more processors, such as processor 2404. Processor 2404 may be, for example, a special purpose processor, general purpose processor, microprocessor, or digital signal processor. Processor 2404 may be connected to a communication infrastructure 2402 (for example, a bus or network). Computer system 2400 may also include a main memory 2406, such as random access memory (RAM), and may also include a secondary memory 2408.

Secondary memory 2408 may include, for example, a hard disk drive 2410 and/or a removable storage drive 2412, representing a magnetic tape drive, an optical disk drive, or the like. Removable storage drive 2412 may read from and/or write to a removable storage unit 2416 in a well-known manner. Removable storage unit 2416 represents a magnetic tape, optical disk, or the like, which is read by and written to by removable storage drive 2412. As will be appreciated by persons skilled in the relevant art(s), removable storage unit 2416 includes a computer usable storage medium having stored therein computer software and/or data.

In alternative implementations, secondary memory 2408 may include other similar means for allowing computer programs or other instructions to be loaded into computer system 2400. Such means may include, for example, a removable storage unit 2418 and an interface 2414. Examples of such means may include a program cartridge and cartridge interface (such as that found in video game devices), a removable memory chip (such as an EPROM or PROM) and associated socket, a thumb drive and USB port, and other removable storage units 2418 and interfaces 2414 which allow software and data to be transferred from removable storage unit 2418 to computer system 2400.

Computer system 2400 may also include a communications interface 2420. Communications interface 2420 allows software and data to be transferred between computer system 2400 and external devices. Examples of communications interface 2420 may include a modem, a network interface (such as an Ethernet card), a communications port, etc. Software and data transferred via communications interface 2420 are in the form of signals which may be electronic, electromagnetic, optical, or other signals capable of being received by communications interface 2420. These signals are provided to communications interface 2420 via a communications path 2422. Communications path 2422 carries signals and may be implemented using wire or cable, fiber optics, a phone line, a cellular phone link, an RF link, and other communications channels.

As used herein, the terms “computer program medium” and “computer readable medium” are used to refer to tangible storage media, such as removable storage units 2416 and 2418 or a hard disk installed in hard disk drive 2410. These computer program products are means for providing software to computer system 2400. Computer programs (also called computer control logic) may be stored in main memory 2406 and/or secondary memory 2408. Computer programs may also be received via communications interface 2420. Such computer programs, when executed, enable the computer system 2400 to implement the present disclosure as discussed herein. In particular, the computer programs, when executed, enable processor 2404 to implement the processes of the present disclosure, such as any of the methods described herein. Accordingly, such computer programs represent controllers of the computer system 2400.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the art.

What is claimed is:

1. A method comprising:
searching, by a decoder, first candidate templates in a first search region and second candidate templates in a second search region to select a reference template based on calculating template matching (TM) costs comprising first TM costs of the first candidate templates and second TM costs of the second candidate templates, wherein:
the first candidate templates, of first candidate reference blocks (RBs) from the first search region, each corresponds to a current template of a current block (CB); and
the second candidate templates, of second candidate RBs from the second search region, each corresponds to the current template flipped in a direction; and
decoding the CB based on a RB indicated by the reference template.

2. The method of claim 1, further comprising:
receiving, in a bitstream, an indication of the CB being encoded in a template matching prediction (TMP) mode that searches for candidate templates that are flipped in the direction relative to the current template, wherein the determining the first candidate templates and the determining the second candidate templates are based on the receiving the indication.

3. The method of claim 1, wherein the decoding the CB comprises:
determining a reconstructed block based on combining the RB with a residual of the CB;
determining whether to flip the reconstructed block in the direction based on whether the reference template is one of the first candidate templates or the second candidate templates; and
decoding the CB based on whether to flip the reconstructed block in the direction.

4. The method of claim 1, wherein:
each of the first candidate templates matches in shape, orientation, and size with the current template; and
each of the second candidate templates matches in shape, orientation, and size with the current template flipped in the direction.

5. The method of claim 1, wherein the first search region is different from the second search region, and wherein the second search region is defined based on the direction of flipping.

6. The method of claim 5, wherein the second search region comprises:
a first rectangular region located above and to the left of the CB; and
a second rectangular region, wherein:
based on the direction being horizontal, the second rectangular region is adjacent to and located to the left of the CB; and
based on the direction being vertical, the second rectangular region is adjacent to and located above the CB.

7. The method of claim 1, further comprising
searching, in a third search region and by the decoder, third candidate templates, of third candidate RBs from the third search region, that each corresponds to the current template flipped in a second direction, wherein the third search region is defined based on the second direction, and wherein:
the TM costs further comprises third TM costs of the third candidate templates; and
the reference template is selected from the first candidate templates, the second candidate templates, and the third candidate templates.

8. A decoder comprising:
one or more processors; and
memory storing instructions that, when executed by the one or more processors, cause the decoder to:
search first candidate templates in a first search region and second candidate templates in a second search region to select a reference template based on calculating template matching (TM) costs comprising first TM costs of the first candidate templates and second TM costs of the second candidate templates, wherein:
the first candidate templates, of first candidate reference blocks (RBs) from the first search region, each corresponds to a current template of a current block (CB); and
the second candidate templates, of second candidate RBs from the second search region, each corresponds to the current template flipped in a direction; and
decode the CB based on a RB indicated by the reference template.

9. The decoder of claim 8, wherein the instructions further cause the decoder to:
receive, in a bitstream, an indication of the CB being encoded in a template matching prediction (TMP) mode that searches for candidate templates that are flipped in the direction relative to the current template, wherein the determining the first candidate templates and the determining the second candidate templates are based on the receiving the indication.

10. The decoder of claim 8, wherein to decode the CB, the instructions further cause the decoder to:
determine a reconstructed block based on combining the RB with a residual of the CB;
determine whether to flip the reconstructed block in the direction based on whether the reference template is one of the first candidate templates or the second candidate templates; and
decode the CB based on whether to flip the reconstructed block in the direction.

11. The decoder of claim 8, wherein:
each of the first candidate templates matches in shape, orientation, and size with the current template; and
each of the second candidate templates matches in shape, orientation, and size with the current template flipped in the direction.

12. The decoder of claim 8, wherein the first search region is different from the second search region, and wherein the second search region is defined based on the direction of flipping.

13. The decoder of claim 12, wherein the second search region comprises:
a first rectangular region located above and to the left of the CB; and
a second rectangular region, wherein:
based on the direction being horizontal, the second rectangular region is adjacent to and located to the left of the CB; and
based on the direction being vertical, the second rectangular region is adjacent to and located above the CB.

14. The decoder of claim 8, wherein the instructions further cause the decoder to:
search, in a third search region and by the decoder, third candidate templates, of third candidate RBs from the third search region, that each corresponds to the current template flipped in a second direction, wherein the third search region is defined based on the second direction, and wherein:
the TM costs further comprises third TM costs of the third candidate templates; and
the reference template is selected from the first candidate templates, the second candidate templates, and the third candidate templates.

15. A non-transitory computer-readable medium comprising instructions that, when executed by one or more processors of a decoder, cause the decoder to:
search first candidate templates in a first search region and second candidate templates in a second search region to select a reference template based on calculating template matching (TM) costs comprising first TM costs of the first candidate templates and second TM costs of the second candidate templates, wherein:
the first candidate templates, of first candidate reference blocks (RBs) from the first search region, each corresponds to a current template of a current block (CB); and
the second candidate templates, of second candidate RBs from the second search region, each corresponds to the current template flipped in a direction; and
decode the CB based on a RB indicated by the reference template.

16. The non-transitory computer-readable medium of claim 15, wherein the instructions further cause the decoder to:
receive, in a bitstream, an indication of the CB being encoded in a template matching prediction (TMP) mode that searches for candidate templates that are flipped in the direction relative to the current template, wherein the determining the first candidate templates and the determining the second candidate templates are based on the receiving the indication.

17. The non-transitory computer-readable medium of claim 15, wherein to decode the CB, the instructions further cause the decoder to:
determine a reconstructed block based on combining the RB with a residual of the CB;
determine whether to flip the reconstructed block in the direction based on whether the reference template is one of the first candidate templates or the second candidate templates; and
decode the CB based on whether to flip the reconstructed block in the direction.

18. The non-transitory computer-readable medium of claim 15, wherein the first search region is different from the second search region, and wherein the second search region is defined based on the direction of flipping.

19. The non-transitory computer-readable medium of claim 18, wherein the second search region comprises:
a first rectangular region located above and to the left of the CB; and
a second rectangular region, wherein:
based on the direction being horizontal, the second rectangular region is adjacent to and located to the left of the CB; and
based on the direction being vertical, the second rectangular region is adjacent to and located above the CB.

20. The non-transitory computer-readable medium of claim 15, wherein the instructions further cause the decoder to:
search, in a third search region and by the decoder, third candidate templates, of third candidate RBs from the third search region, that each corresponds to the current template flipped in a second direction, wherein the third search region is defined based on the second direction, and wherein:
the TM costs further comprises third TM costs of the third candidate templates; and
the reference template is selected from the first candidate templates, the second candidate templates, and the third candidate templates.
